(19) United States
(12) Patent Application Publication
(10) Pub. No.: US 2015/0092145 A1
(43) Pub. Date: Apr. 2, 2015

(54) LIQUID CRYSTAL DISPLAY DEVICE AND METHOD FOR MANUFACTURING SAME

(71) Applicant: Sharp Kabushiki Kaisha, Osaka-shi, Osaka (JP)

(72) Inventor: Masanobu Mizusaki, Osaka-shi (JP)

(21) Appl. No.: 14/396,789

(22) PCT Filed: Apr. 25, 2013
(86) PCT No.: PCT/JP2013/062177

§ 371 Date: Oct. 24, 2014

(30) Foreign Application Priority Data
Apr. 27, 2012 (JP) 2012-102605

(51) Int. Cl. G02F 1/1337; C09K 19/38; C09K 19/56

(52) U.S. Cl. CPC G02F 1/133711; C09K 19/56; C09K 19/3809
USPC 349/123; 445/24

(57) ABSTRACT

A liquid crystal display device includes a pair of substrates, a liquid crystal layer that is disposed between the pair of substrates and includes a liquid crystal molecule, an alignment film that is disposed between each of the pair of substrates and the liquid crystal layer and includes a macromolecule containing a functional group having dielectric anisotropy, and a polymer layer that is disposed between the alignment film and the liquid crystal layer and includes a polymer of a polymerizable monomer. The polymerizable monomer preferably includes a compound having a specific ring structure, a compound having a structure capable of undergoing photoirradiation-induced hydrogen abstraction reaction to produce a ketyl radical, or a compound having at least two radically-polymerizable groups and a structure capable of undergoing photoirradiation-induced self-cleavage reaction to produce radicals.

### TECHNICAL FIELD

The invention relates to a liquid crystal display device and a method for manufacture thereof. More specifically, the invention relates to a liquid crystal display device having an alignment film that is disposed between a substrate and a liquid crystal layer and includes a macromolecule containing a functional group having dielectric anisotropy, and also relates to a method for manufacturing such a liquid crystal display device.

### BACKGROUND ART

Liquid crystal display devices are used in a variety of applications such as liquid crystal televisions and cellular phones because of advantages such as low power consumption, slimness, and light weight.

Liquid crystal display devices are required to have a short response time (rise response time) for smooth moving-image display and residual image suppression. Unfortunately, some conventional liquid crystal display devices have a very long response time such as 30 ms or more. Such low response characteristics are caused by fluctuations in the orientation direction of liquid crystal molecule in a liquid crystal bulk layer. To solve such a problem, a technique is proposed, for example, in Patent Documents 1 and 2 to use an alignment film that is provided between a substrate and a liquid crystal layer and includes a macromolecule containing a functional group having dielectric anisotropy.

### CITATION LIST

### Patent Document

### PTD 1: Japanese Patent Laying-Open No. 2011-102963

### PTD 2: National Patent Publication No. 2007-521506

### SUMMARY OF INVENTION

### Technical Problem

The use of an alignment film including a macromolecule containing a functional group having dielectric anisotropy is effective in improving the response characteristics. On the other hand, however, the introduction of the functional group having dielectric anisotropy changes the state of the relationship between the liquid crystal layer and the alignment film, which causes a problem such as degradation of voltage holding ratio (VHR) and residual DC voltage (rDC).

Thus, the invention aims to provide a liquid crystal display device that has a short rise response time, a high VHR, and a low rDC while it has an alignment film that is disposed between a substrate and a liquid crystal layer and includes a macromolecule containing a functional group having dielectric anisotropy, and to provide a method for manufacturing such a liquid crystal display device.

### Solution to Problem

The invention encompasses the following aspects.

[1] A liquid crystal display device, including:

a pair of substrates;

a liquid crystal layer that is disposed between the pair of substrates and includes a liquid crystal molecule;

an alignment film that is disposed between each of the pair of substrates and the liquid crystal layer and includes a macromolecule containing a functional group having dielectric anisotropy; and

a polymer layer that is disposed between the alignment film and the liquid crystal layer and includes a polymer of a polymerizable monomer.

[2] The liquid crystal display device according to [1], wherein the polymerizable monomer includes at least one polymerizable monomer represented by formula (1):

P1-A1-(Z1-A2)n-P2 (1)

wherein

P1 and P2 are the same or different and each represent an acryloyloxy, methacryloyloxy, acryloylamino, methacryloylamino, vinyl, or vinyloxy group,

A1 and A2 are the same or different and each represent a 1,4-phenylene, 4,4′-biphenylene, naphthalene-2,6-diyl, anthracene-2,6-diyl, phenanthrene-2,7-diyl, phenanthrene-3,6-diyl, phenanthrene-1,6-diyl, or phenanthrene-1,8-diyl group, at least one hydrogen atom in A1 and A2 may be substituted with a halogen atom or a methyl group,

Z1 represents COO, OCO, O, CO, NHCO, CONH, or S, or represents a direct bond between A1 and A2 or between A2 and A2, and

n is 0, 1, or 2.

[3] The liquid crystal display device according to [2], wherein in formula (1), P1 and P2 are the same or different and each represent an acryloyloxy, methacryloyloxy, acryloylamino, or methacryloylamino group.

[4] The liquid crystal display device according to [2] or [3], wherein in formula (1), P1 and P2 are the same or different and each represent an acryloyloxy or methacryloyloxy group, A1 represents a phenanthrene-2,7-diyl group, and n is 0.

[5] The liquid crystal display device according to [1], wherein the polymerizable monomer includes a compound having a structure capable of undergoing a photoirradiation-induced hydrogen abstraction reaction to produce a ketyl radical.

[6] The liquid crystal display device according to [5], wherein the compound having a structure capable of undergoing a photoirradiation-induced hydrogen abstraction reaction to produce a ketyl radical includes at least one polymerizable monomer represented by formula (2):

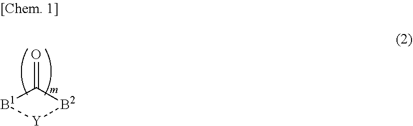

wherein

B1 and B2 are the same or different and each represent a benzene ring, a biphenyl ring, or a linear or branched alkyl or alkenyl group of 1 to 12 carbon atoms, at least one of B1 and B2 represents a benzene ring or a biphenyl ring, and at least one of B1 and B2 contains an -Sp1-P3 group, at least one hydrogen atom in B1 and B2 may be substituted with an -Sp1-P3 group, a halogen atom, a —CN, —NO₂, —NCO, —NCS, —OCN, —SCN, or —SF₅ group, or a linear or branched alkyl, alkenyl, or aralkyl group of 1 to 12 carbon atoms, two adjacent hydrogen atoms in B1 and B2 may be substituted with a linear or branched alkylene or alkenylene group of 1 to 12 carbon atoms so that a ring structure can be formed, at least one hydrogen atom of an alkyl, alkenyl, alkylene, alkenylene, or aralkyl group in B1 and B2 may be substituted with an -Sp1-P3 group, each —CH₂— group in an alkyl, alkenyl, alkylene, alkenylene, or aralkyl group in B1 and B2 may be substituted with an —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that there are no adjacent oxygen, sulfur, and nitrogen atoms,

P3 represents a radically-polymerizable group,

Sp1 represents a linear, branched, or cyclic alkylene or alkyleneoxy group of 1 to 6 carbon atoms, or a direct bond,

m is 1 or 2,

a dotted line linking B1 and Y and a dotted line linking B2 and Y indicate that a linkage may exist between B1 and B2 with Y interposed therebetween, and

Y represents a —CH₂—, —CH₂CH₂—, —CH═CH—, —O—, —S—, —NH—, —N(CH₃)—, —N(C₂H₅)—, —N(C₃H₇)—, —N(C₄H₉)—, —OCH₂—, —CH₂O—, —SCH₂—, or —CH₂S— group, or a direct bond.

[7] The liquid crystal display device according to [6], wherein the compound represented by formula (2) is at least one of compounds represented by formulae (2-1) to (2-8):

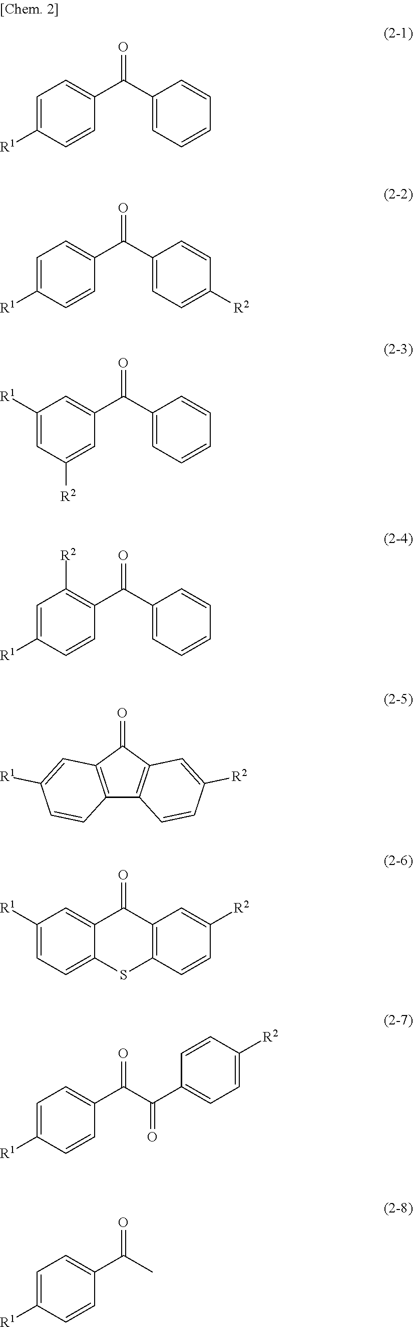

wherein

R1 and R2 are the same or different and each represent an -Sp1-P3 group, a hydrogen atom, a halogen atom, a —CN, —NO₂, —NCO, —NCS, —OCN, —SCN, or —SF₅ group, or a linear or branched alkyl, aralkyl, or phenyl group of 1 to 12 carbon atoms, at least one of R1 and R2 includes an -Sp1-P3 group,

P3 represents a radically-polymerizable group,

Sp1 represents a linear, branched, or cyclic alkylene or alkyleneoxy group of 1 to 6 carbon atoms, or a direct bond,

when R1 and R2 are linear or branched alkyl, aralkyl, or phenyl groups of 1 to 12 carbon atoms, at least one hydrogen atom in R1 and R2 may be substituted with a fluorine atom, a chlorine atom, or an -Sp1-P3 group, and a —CH₂— group in R1 and R2 may be substituted with an —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that there are no adjacent oxygen, sulfur, and nitrogen atoms.

[8] The liquid crystal display device according to [6] or [7], wherein P3 represents an acryloyloxy, methacryloyloxy, acryloylamino, methacryloylamino, vinyl, or vinyloxy group.

[9] The liquid crystal display device according to [1], wherein the polymerizable monomer includes a compound having at least two radically-polymerizable groups and a structure capable of undergoing a photoirradiation-induced self-cleavage reaction to produce a radical.

[10] The liquid crystal display device according to [9], wherein the compound having at least two radically-polymerizable groups and a structure capable of undergoing a photoirradiation-induced self-cleavage reaction to produce a radical includes at least one polymerizable monomer represented by formula (3):

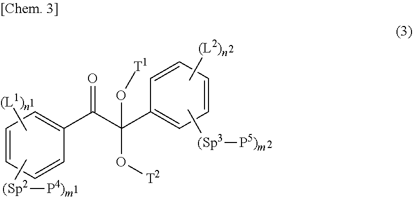

wherein

T1 represents a linear or branched alkyl or alkenyl group of 1 to 4 carbon atoms or Sp4-P6,

T2 represents a linear or branched alkyl or alkenyl group of 1 to 4 carbon atoms or Sp5-P7,

P4, P5, P6, and P7 are the same or different and each represent a radically-polymerizable group, wherein the total number of radically-polymerizable groups is equal to or greater than 2,

Sp2 represents a linear, branched, or cyclic alkylene, alkyleneoxy, or alkylenecarbonyloxy group of 1 to 6 carbon atoms, or a direct bond, when m1 is equal to or greater than 2, at least two occurrences of Sp2 may be the same or different,

Sp3 represents a linear, branched, or cyclic alkylene, alkyleneoxy, or alkylenecarbonyloxy group of 1 to 6 carbon atoms, or a direct bond, when m2 is equal to or greater than 2, at least two occurrences of Sp3 may be the same or different,

Sp4 represents a linear, branched, or cyclic alkylene, alkyleneoxy, or alkylenecarbonyloxy group of 1 to 6 carbon atoms,

Sp5 represents a linear, branched, or cyclic alkylene, alkyleneoxy, or alkylenecarbonyloxy group of 1 to 6 carbon atoms,

L1 represents a fluorine atom, an —OH group, or a linear or branched alkyl, alkenyl, or aralkyl group of 1 to 12 carbon atoms, when n1 is equal to or greater than 2, at least two occurrences of L1 may be the same or different,

when two L1 moieties are bonded to two adjacent carbon atoms, respectively, on an aromatic ring, the two L1 moieties may be linked together to form a ring structure, and the two L1 moieties are the same or different and each a linear or branched alkylene or alkenylene group of 1 to 12 carbon atoms,

L2 represents a fluorine atom, an —OH group, or a linear or branched alkyl, alkenyl, or aralkyl group of 1 to 12 carbon atoms, when n2 is equal to or greater than 2, at least two occurrences of L2 may be the same or different,

when two L2 moieties are bonded to two adjacent carbon atoms, respectively, on an aromatic ring, the two L2 moieties may be linked together to form a ring structure, and the two L2 moieties are the same or different and each a linear or branched alkylene or alkenylene group of 1 to 12 carbon atoms,

at least one hydrogen atom of an alkyl, alkenyl, alkylene, alkenylene, or aralkyl group in L1 and L2 may be substituted with a fluorine atom or an —OH group,

each —CH₂— group in an alkyl, alkenyl, alkylene, alkenylene, or aralkyl group in L1 and L2 may be substituted with an —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that there are no adjacent oxygen, sulfur, and nitrogen atoms,

m1 is an integer of 1 to 3,

m2 is an integer of 0 to 3,

n1 is an integer of 0 to 4,

n2 is an integer of 0 to 4,

the sum of m1 and n1 is an integer of 1 to 5,

the sum of m2 and n2 is an integer of 0 to 5, and

the sum of m1 and m2 is an integer of 1 to 6.

[11] The liquid crystal display device according to [9] or [10], wherein the radically-polymerizable group is an acryloyloxy, methacryloyloxy, acryloylamino, methacryloylamino, vinyl, or vinyloxy group.

[12] The liquid crystal display device according to [9], wherein the compound having at least two radically-polymerizable groups and a structure capable of undergoing a photoirradiation-induced self-cleavage reaction to produce a radical includes at least one polymerizable monomer represented by formula (4):

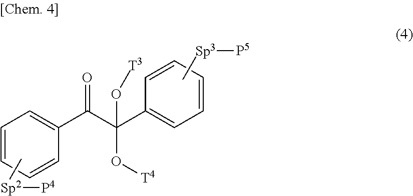

wherein

T3 represents a linear or branched alkyl or alkenyl group of 1 to 4 carbon atoms,

T4 represents a linear or branched alkyl or alkenyl group of 1 to 4 carbon atoms,

P4 and P5 are the same or different and each represent a radically-polymerizable group,

Sp2 represents a linear, branched, or cyclic alkylene, alkyleneoxy, or alkylenecarbonyloxy group of 1 to 6 carbon atoms, or a direct bond, and

Sp3 represents a linear, branched, or cyclic alkylene, alkyleneoxy, or alkylenecarbonyloxy group of 1 to 6 carbon atoms, or a direct bond.

[13] The liquid crystal display device according to any one of [5] to [12], wherein the polymerizable monomer further includes a polymerizable monomer having at least one ring structure and a polyfunctional polymerizable group.

[14] The liquid crystal display device according to [13], wherein the polymerizable monomer having at least one ring structure and a polyfunctional polymerizable group includes at least one polymerizable monomer represented by formula (5):

P8-S1-B3-(Z2-B4)k-S2-P9 (5)

wherein

P8 and P9 are the same or different and each represent an acryloyloxy, methacryloyloxy, acryloylamino, methacryloylamino, vinyl, or vinyloxy group,

B3 and B4 are the same or different and each represent a 1,4-phenylene, 4,4′-biphenylene, naphthalene-2,6-diyl, anthracene-2,6-diyl, phenanthrene-2,7-diyl, phenanthrene-3,6-diyl, phenanthrene-1,6-diyl, or phenanthrene-1,8-diyl group, at least one hydrogen atom in B3 and B4 may be substituted with a halogen atom or a methyl group,

Z2 represents COO, OCO, O, CO, NHCO, CONH, or S, or represents a direct bond between B3 and B4 or between B4 and B4,

k is 0, 1, or 2, and

S1 and S2 are the same or different and each represent (CH₂)ᵢ, wherein i is an integer of 1 to 18, (CH₂—CH₂—O)ⱼ, wherein j is an integer of 1 to 6, or a direct bond between P8 and B3, between B3 and P9, or between B4 and P9.

[15] The liquid crystal display device according to [14], wherein the compound represented by formula (5) is at least one of compounds represented by formulae (5-1) to (5-4):

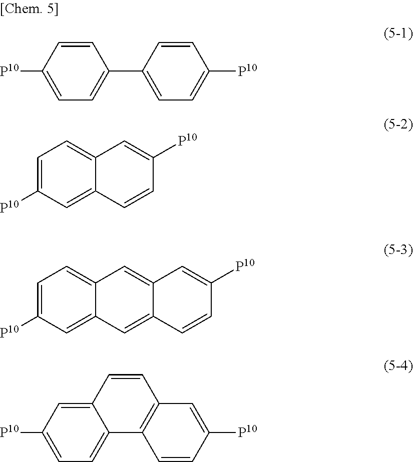

wherein at least two occurrences of P10 are the same or different and each represent an acryloyloxy, methacryloyloxy, acryloylamino, methacryloylamino, vinyl, or vinyloxy group.

[16] The liquid crystal display device according to any one of [1] to [15], wherein the alignment film includes a macromolecule containing a functional group having positive dielectric anisotropy.

[17] The liquid crystal display device according to any one of [1] to [15], wherein the alignment film includes a macromolecule containing a functional group having negative dielectric anisotropy.

[18] The liquid crystal display device according to any one of [1] to [17], wherein the alignment film is a polyimide, polyamide, polyvinyl alcohol, polyvinyl acetal, polysiloxane, polyorganosiloxane, polymaleimide, or derivative of any of the foregoing containing, in a side chain, a functional group having dielectric anisotropy.

[19] The liquid crystal display device according to any one of [1] to [18], wherein the alignment film regularly aligns the liquid crystal molecule in a direction vertical to the surface of the alignment film when no voltage is applied to the liquid crystal layer.

[20] The liquid crystal display device according to any one of [1] to [18], wherein the alignment film regularly aligns the liquid crystal molecule in a direction horizontal to the surface of the alignment film when no voltage is applied to the liquid crystal layer.

[21] The liquid crystal display device according to any one of [1] to [18], wherein the alignment film regularly aligns the liquid crystal molecule in a direction oblique to the surface of the alignment film when no voltage is applied to the liquid crystal layer.

[22] The liquid crystal display device according to any one of [1] to [21], wherein the liquid crystal layer includes a liquid crystal molecule having positive dielectric anisotropy.

[23] The liquid crystal display device according to any one of [1] to [21], wherein the liquid crystal layer includes a liquid crystal molecule having negative dielectric anisotropy.

[24] A method for manufacturing the liquid crystal display device according to [1], the method including the steps of:

forming the alignment film on at least one surface of each of the pair of substrates;

arranging the pair of substrates opposite to each other with the alignment film placed inside;

introducing a liquid crystal composition between the pair of substrates, wherein the liquid crystal composition contains the liquid crystal molecule and the polymerizable monomer; and

polymerizing the polymerizable monomer to form the polymer layer.

[25] The method according to [24], wherein the polymerizable monomer is that recited in any one of [2] to [15].

[26] The method according to [24] or [25], wherein the polymer layer-forming step includes the step of polymerizing the polymerizable monomer while a voltage equal to or greater than a threshold for liquid crystal response is applied to the liquid crystal composition.

[27] The method according to [24] or [25], wherein the polymer layer-forming step includes the step of polymerizing the polymerizable monomer while a voltage less than a threshold for liquid crystal response is applied to the liquid crystal composition.

[28] The method according to [24] or [25], wherein the polymer layer-forming step includes the step of polymerizing the polymerizable monomer with no voltage applied to the liquid crystal composition.

[29] The method according to any one of [24] to [28], wherein the polymer layer-forming step includes the step of polymerizing the polymerizable monomer by photoirradiation of the liquid crystal composition.

### Advantageous Effects of Invention

The invention makes it possible to provide a liquid crystal display device having a short rise response time, a high VHR, and a low rDC.

### BRIEF DESCRIPTION OF DRAWINGS

FIG. 1(a) is a schematic diagram showing part of a liquid crystal display device according to the invention in an enlarged manner.

FIG. 1(b) is a schematic diagram showing part of a conventional liquid crystal display device in an enlarged manner.

FIG. 2(a) is a graph showing the results of measurement of the capacitance-voltage characteristics for Example 26 and Comparative Examples 1 and 2.

FIG. 2(b) is a graph showing part of FIG. 2(a) in an enlarged manner.

### DESCRIPTION OF EMBODIMENTS

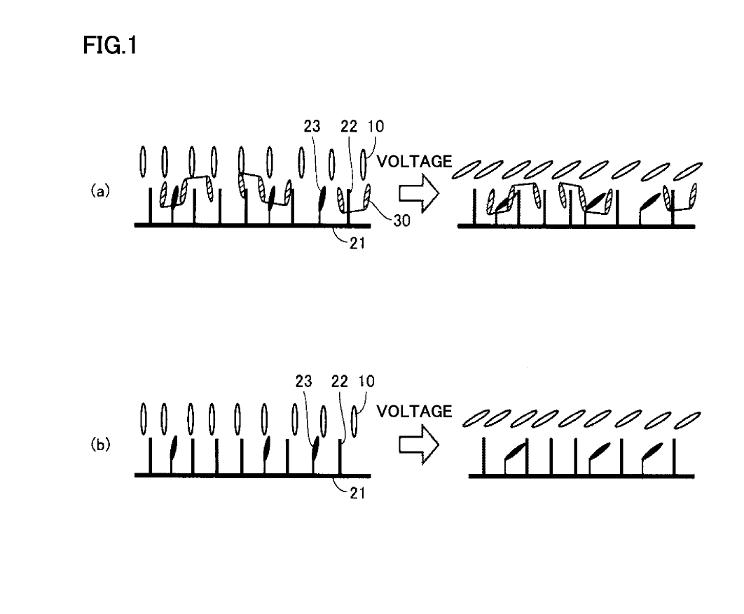

The liquid crystal display device (LCD) of the invention is a polymer sustained alignment (PSA) LCD including a pair of substrates, a liquid crystal layer that is disposed between the pair of substrates and includes a liquid crystal molecule, an alignment film disposed between each of the pair of substrates and the liquid crystal layer, and a polymer layer disposed between the alignment film and the liquid crystal layer. FIG. 1(a) shows part of the liquid crystal display device in an enlarged manner. Referring to FIG. 1(a), the alignment film includes a macromolecule 21 containing a functional group 23 having dielectric anisotropy, in which the macromolecule contains functional group 23 typically in its side chain 22. As shown in FIG. 1(a), the polymer layer is a layer including a polymer 30 of a polymerizable monomer and disposed between the alignment film and the liquid crystal layer including a liquid crystal molecule 10. The polymer layer imparts a certain pretilt angle to liquid crystal molecule 10. For reference, FIG. 1(b) schematically shows a conventional liquid crystal display device having no polymer layer.

The LCD of the invention has a high VHR and a low rDC while maintaining a short rise response time because it includes not only the alignment film including macromolecule 21 containing functional group 23 having dielectric anisotropy but also the polymer layer including polymer 30 and disposed between the alignment film and the liquid crystal layer.

In order to obtain the advantageous effects, the alignment film may serve to regularly align the liquid crystal molecule in a direction vertical, horizontal, or oblique to the surface of the alignment film when no voltage is applied to the liquid crystal layer. The liquid crystal layer may include a liquid crystal molecule having positive dielectric anisotropy or a liquid crystal molecule having negative dielectric anisotropy.

Hereinafter, the liquid crystal display device according to the invention and the method according to the invention for manufacture thereof will be described in more detail.

<Liquid Crystal Display Device>

(1) Polymer Layer

The polymer layer is a layer obtained by polymerization of a polymerizable monomer. Typically, the polymerizable monomer is mixed with the liquid crystal molecule used to form the liquid crystal layer, and the liquid crystal composition containing the liquid crystal molecule and the polymerizable monomer is injected between the pair of substrates. After the injection of the liquid crystal composition, the polymerizable monomer is polymerized (cured) by subjecting the liquid crystal composition to photoirradiation or other processes so that the polymer layer is formed. The content of the polymerizable monomer (when two or more polymerizable monomers are used, the total content of the polymerizable monomers) in the liquid crystal composition is generally from 0.05 to 1.5% by weight, preferably from 0.1 to 0.7% by weight, based on the amount of the liquid crystal molecule.

In the invention, at least one of compounds [a] to [c] shown below is preferably used as the polymerizable monomer in order to achieve a high VHR and a low rDC while keeping the rise response time short, particularly, in order to achieve a high VHR and a low rDC.

[a] A compound represented by formula (1): P1-A1-(Z1-A2)n-P2 (hereinafter also referred to as “compound a”).

[b] A compound having a structure capable of undergoing a photoirradiation-induced hydrogen abstraction reaction to produce a ketyl radical (hereinafter also referred to as “compound b”).

[c] A compound having at least two radically-polymerizable groups and a structure capable of undergoing a photoirradiation-induced self-cleavage reaction to produce a radical (hereinafter also referred to as “compound c”).

(Compound a)

Compound a is represented by formula (1) shown above. The polymerizable monomer may include only one compound a, or two or more compounds a.

In formula (1), P1 and P2 are the same or different and each represent a radically-polymerizable group selected from acryloyloxy, methacryloyloxy, acryloylamino, methacryloylamino, vinyl, and vinyloxy groups, preferably the same or different and each an acryloyloxy, methacryloyloxy, acryloylamino, or methacryloylamino group, more preferably the same or different and each an acryloyloxy or methacryloyloxy group.

A1 and A2 are the same or different and each represent a 1,4-phenylene, 4,4′-biphenylene, naphthalene-2,6-diyl, anthracene-2,6-diyl, phenanthrene-2,7-diyl, phenanthrene-3,6-diyl, phenanthrene-1,6-diyl, or phenanthrene-1,8-diyl group. At least one hydrogen atom in A1 and A2 may be substituted with a halogen atom or a methyl group. A1 and A2 are preferably the same or different and each represent a naphthalene-2,6-diyl, anthracene-2,6-diyl, phenanthrene-2,7-diyl, phenanthrene-3,6-diyl, phenanthrene-1,6-diyl, or phenanthrene-1,8-diyl group, more preferably the same or different and each a phenanthrene-2,7-diyl, phenanthrene-3,6-diyl, phenanthrene-1,6-diyl, or phenanthrene-1,8-diyl group, so that a higher VHR and a lower rDC can be achieved.

Z1 represents C(═O)O, O—C(═O), O, C(═O), NH—C(═O), C(═O)—NH, or S, or represents a direct bond between A1 and A2 or between A2 and A2 (when n=2), and n is 0, 1, or 2, preferably 0 or 1.

As mentioned above, the polymerizable monomer may include only one compound a, or two or more compounds a. The use of a combination of two or more compounds a can further improve VHR and rDC. In addition to compound a, the polymerizable monomer may include one or more compounds b described below and/or one or more compounds c described below. Also in this case, VHR and rDC can be further improved.

(Compound b)

Compound b is a compound having a structure capable of undergoing a photoirradiation-induced hydrogen abstraction reaction to produce a ketyl radical. The polymerizable monomer may include only one compound b or two or more compounds b. When the polymerizable monomer includes compound b, the polymer layer can be formed by irradiating the liquid crystal composition with light such as ultraviolet rays.

The use of compound b as the polymerizable monomer (for example, the use of compound b alone, or the use of compound b in combination with compound a or compound d described below as the polymerizable monomer) can further improve VHR and/or rDC as compared to the case where compound a or compound d described below is used alone. The polymerizable monomer including compound b are advantageous in that the time required for the process of forming the polymer layer can be reduced (a liquid crystal display device with a desired level of rise response time, VHR, and rDC can be obtained even with a short photoirradiation time).

Preferred examples of compound b include compounds represented by formula (2) shown above. Upon photoirradiation, the carbonyl group shown in formula (2) is converted to a ketyl radical. The number m of carbonyl groups is 1 or 2. In formula (2), B1 and B2 are the same or different and each represent a benzene ring, a biphenyl ring, or a linear or branched alkyl or alkenyl group of 1 to 12 carbon atoms, and at least one of B1 and B2 represents a benzene ring or a biphenyl ring. At least one of B1 and B2 preferably represents a benzene ring.

At least one of B1 and B2 has an -Sp1-P3 group. P3 represents a radically-polymerizable group, preferably an acryloyloxy, methacryloyloxy, acryloylamino, methacryloylamino, vinyl, or vinyloxy group, more preferably an acryloyloxy, methacryloyloxy, acryloylamino, or methacryloylamino group, even more preferably an acryloyloxy or methacryloyloxy group. Sp1 represents a linear, branched, or cyclic alkylene or alkyleneoxy group of 1 to 6 carbon atoms, or a direct bond.

At least one hydrogen atom in B1 and B2 may be substituted with the -Sp1-P3 group, a halogen atom, a —CN, —NO₂, —NCO, —NCS, —OCN, —SCN, or —SF₅ group, or a linear or branched alkyl, alkenyl, or aralkyl group of 1 to 12 carbon atoms. In this case, two adjacent hydrogen atoms in B1 and B2 may be substituted with a linear or branched alkylene or alkenylene group of 1 to 12 carbon atoms so that a ring structure can be formed. When B1 and B2 have an alkyl, alkenyl, alkylene, alkenylene, or aralkyl group, at least one hydrogen atom in any of these groups may be substituted with an -Sp1-P3 group. Each —CH₂— group in the alkyl, alkenyl, alkylene, alkenylene, or aralkyl group in B1 and B2 may be substituted with an —O—, —S—, —NH—, —C(═O)—, —C(═O)O—, —O—C(═O)—, —O—C(═O)O—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—C(═O)O—, or —O—C(═O)—CH═CH— group, provided that there are no adjacent oxygen, sulfur, and nitrogen atoms.

The dotted line linking B1 and Y and the dotted line linking B2 and Y indicate that a linkage may exist between B1 and B2 with Y interposed therebetween, in which Y represents a —CH₂—, —CH₂CH₂—, —CH═CH—, —O—, —S—, —NH—, —N(CH₃)—, —N(C₂H₅)—, —N(C₃H₇)—, —N(C₄H₉)—, —OCH₂—, —CH₂O—, —SCH₂—, or —CH₂S— group, or a direct bond.

In view of the effect of improving VHR and rDC and easy availability, preferred examples of the compound represented by formula (2) include compounds represented by formulae (2-1) to (2-8) shown above. In formulae (2-1) to (2-8), R1 and R2 are the same or different and each represent an -Sp1-P3 group, a hydrogen atom, a halogen atom, a —CN, —NO₂, —NCO, —NCS, —OCN, —SCN, of —SF₅ group, or a linear or branched alkyl, aralkyl, or phenyl group of 1 to 12 carbon atoms, and at least one of R1 and R2 includes an -Sp1-P3 group. P3 and Sp1 have the same meanings as defined above.

When R1 and R2 are linear or branched alkyl, aralkyl, or phenyl groups of 1 to 12 carbon atoms, at least one hydrogen atom in R1 and R2 may be substituted with the -Sp1-P3 group, a fluorine atom, or a chlorine atom. When R1 and R2 have a —CH₂— group, the —CH₂— group may be substituted with an —O—, —S—, —NH—, —C(═O)—, —C(═O)O—, —O—C(═O)—, —O—C(═O)O—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—C(═O)O—, or —O—C(═O)—CH═CH— group, provided that there are no adjacent oxygen, sulfur, and nitrogen atoms.

(Compound c)

Compound c is a compound having at least two radically-polymerizable groups and a structure capable of undergoing a photoirradiation-induced self-cleavage reaction to produce a radical. The polymerizable monomer may include only one compound c or two or more compounds c. When the polymerizable monomer includes compound c, the polymer layer can be formed by irradiating the liquid crystal composition with light such as ultraviolet rays.

The use of compound c as the polymerizable monomer (for example, the use of compound c alone, or the use of compound c in combination with compound a or compound d described below as the polymerizable monomer) can further improve VHR and/or rDC as compared to the case where compound a or compound d described below is used alone. The polymerizable monomer including compound c is advantageous in that the process of forming the polymer layer can be shortened (a liquid crystal display device with a desired level of rise response time, VHR, and rDC can be obtained even with a short photoirradiation time). The polymerizable monomer may include compound b and compound c.

Preferred examples of compound c include compounds represented by formula (3) shown above. Upon photoirradiation, the single bond between the carbonyl group and the C(OT1)(OT2) group shown in formula (3) undergoes a self-cleavage reaction to produce a radical. In formula (3), T1 represents a linear or branched alkyl or alkenyl group of 1 to 4 carbon atoms or Sp4-P6. T2 represents a linear or branched alkyl or alkenyl group of 1 to 4 carbon atoms or Sp5-P7. P4, P5, P6, and P7 are the same or different and each represent a radically-polymerizable group. The compound represented by formula (3) has at least two radically-polymerizable groups in total. The radically-polymerizable group is preferably an acryloyloxy, methacryloyloxy, acryloylamino, methacryloylamino, vinyl, or vinyloxy group, more preferably an acryloyloxy, methacryloyloxy, acryloylamino, or methacryloylamino group, even more preferably an acryloyloxy or methacryloyloxy group.

Sp2 and Sp3 are the same or different and each represent a linear, branched, or cyclic alkylene, alkyleneoxy, or alkylenecarbonyloxy group of 1 to 6 carbon atoms, or a direct bond, m1 is an integer of 1 to 3, and m2 is an integer of 0 to 3. When m1 is equal to or greater than 2, at least two occurrences of Sp2 and at least two occurrences of P4 may be the same or different. When m2 is equal to or greater than 2, at least two occurrences of Sp3 and at least two occurrences of P5 may be the same or different. Sp4 and Sp5 are the same or different and each represent a linear, branched, or cyclic alkylene, alkyleneoxy, or alkylenecarbonyloxy group of 1 to 6 carbon atoms.

L1 and L2 are the same or different and each represent a fluorine atom, an —OH group, or a linear or branched alkyl, alkenyl, or aralkyl group of 1 to 12 carbon atoms, n1 and n2 are the same or different and each an integer of 0 to 4, provided that the sum of m1 and n1 is an integer of 1 to 5, the sum of m2 and n2 is an integer of 0 to 5, and the sum of m1 and m2 is an integer of 1 to 6. When n1 is equal to or greater than 2, at least two occurrences of L1 may be the same or different. When n2 is equal to or greater than 2, at least two occurrences of L2 may be the same or different.

When two L1 moieties are bonded to two adjacent carbon atoms, respectively, on the aromatic ring, the two L1 moieties may be linked together to form a ring structure. In this case, the two L1 moieties are the same or different and each represent a linear or branched alkylene or alkenylene group of 1 to 12 carbon atoms. Also when two L2 moieties are bonded to two adjacent carbon atoms, respectively, on the aromatic ring, the two L2 moieties may be linked together to form a ring structure. In this case, the two L2 moieties are the same or different and each represent a linear or branched alkylene or alkenylene group of 1 to 12 carbon atoms.

When L1 and L2 include an alkyl, alkenyl, alkylene, alkenylene, or aralkyl group, at least one hydrogen atom in any of these groups may be substituted with a fluorine atom or an —OH group. Each —CH₂— group in the alkyl, alkenyl, alkylene, alkenylene, or aralkyl group in L1 and L2 may be substituted with an —O—, —S—, —NH—, —C(═O)—, —C(═O)O—, —O—C(═O)—, —O—C(═O)O—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—C(═O)O—, or —O—C(═O)—CH═CH— group, provided that there are no adjacent oxygen, sulfur, and nitrogen atoms.

In view of the effect of improving VHR and rDC and easy availability, preferred examples of the compound represented by formula (3) include compounds represented by formula (4) shown above. In formula (4), T3 and T4 are the same or different and each represent a linear or branched alkyl or alkenyl group of 1 to 4 carbon atoms. P4, P5, Sp2, and Sp3 have the same meanings as those defined above.

As mentioned above, when the polymerizable monomer includes compound b and/or compound c and an optional polymerizable monomer other than these monomers, VHR and/or rDC can be even more improved while the time required for the process of forming the polymer layer is reduced, as compared to the case where the optional polymerizable monomer is used alone. The optional polymerizable monomer may be, but not limited to, a polymerizable monomer represented by formula (5) shown above, which has at least one ring structure and a polyfunctional polymerizable group (radically-polymerizable group). The polymerizable monomer represented by formula (5) include compound a shown above.

In formula (5), P8 and P9 are the same or different and each represent a radically-polymerizable group selected from acryloyloxy, methacryloyloxy, acryloylamino, methacryloylamino, vinyl, and vinyloxy groups, preferably the same or different and each an acryloyloxy, methacryloyloxy, acryloylamino, or methacryloylamino group, more preferably the same or different and each an acryloyloxy or methacryloyloxy group.

B3 and B4 are the same or different and each represent a 1,4-phenylene, 4,4′-biphenylene, naphthalene-2,6-diyl, anthracene-2,6-diyl, phenanthrene-2,7-diyl, phenanthrene-3,6-diyl, phenanthrene-1,6-diyl, or phenanthrene-1,8-diyl group. At least one hydrogen atom in B3 and B4 may be substituted with a halogen atom or a methyl group. B3 and B4 are preferably the same or different and each represent a naphthalene-2,6-diyl, anthracene-2,6-diyl, phenanthrene-2,7-diyl, phenanthrene-3,6-diyl, phenanthrene-1,6-diyl, or phenanthrene-1,8-diyl group, more preferably the same or different and each a phenanthrene-2,7-diyl, phenanthrene-3,6-diyl, phenanthrene-1,6-diyl, or phenanthrene-1,8-diyl group, so that a higher VHR and a lower rDC can be achieved.

Z2 represents C(═O)O, O—C(═O), O, C(═O), NH—C(═O), C(═O)—NH, or S, or represents a direct bond between B3 and B4 or between B4 and B4 (when k=2), and k is 0, 1, or 2, preferably 0 or 1.

S1 and S2 are the same or different and each represent (CH₂)ᵢ, wherein i is an integer of 1 to 18, (CH₂—CH₂—O)ⱼ, wherein j is an integer of 1 to 6, or a direct bond between P8 and B3, between B3 and P9 (when k=0), or between B4 and P9 (when k=1 or 2).

In view of the effect of improving VHR and rDC and easy availability, preferred examples of the compound represented by formula (5) include compounds represented by formulae (5-1) to (5-4) shown above. These compounds belong to the family of compounds a. In formulae (5-1) to (5-4), P10 has the same meaning as P8 and P9 shown above.

(2) Alignment Film

The alignment film disposed between each of the pair of substrates and the liquid crystal layer may be any of an alignment film configured to regularly align a liquid crystal molecule in a direction vertical to its surface when no voltage is applied to the liquid crystal layer, an alignment film configured to regularly align a liquid crystal molecule in a direction horizontal to its surface when no voltage is applied to the liquid crystal layer, and an alignment film configured to regularly align a liquid crystal molecule in a direction oblique to its surface when no voltage is applied to the liquid crystal layer, as long as it includes a macromolecule containing a functional group having dielectric anisotropy. The introduction of the functional group having dielectric anisotropy makes it possible to achieve a desired rise response time. The functional group having dielectric anisotropy may be a functional group having positive dielectric anisotropy or a functional group having negative dielectric anisotropy. The functional group having dielectric anisotropy is typically contained in the side chain of the macromolecule.

The macromolecule used to form the alignment film is preferably a polyimide, polyamide, polyvinyl alcohol, polyvinyl acetal, polysiloxane, polyorganosiloxane, polymaleimide, or derivative of any of the foregoing containing, in the side chain, a functional group having dielectric anisotropy.

Examples of a macromolecule suitable for use in forming the alignment film are, for example, as follows. Examples of a macromolecule for vertical alignment containing, in the side chain, a functional group having negative dielectric anisotropy include compounds (I) to (VI) shown below.

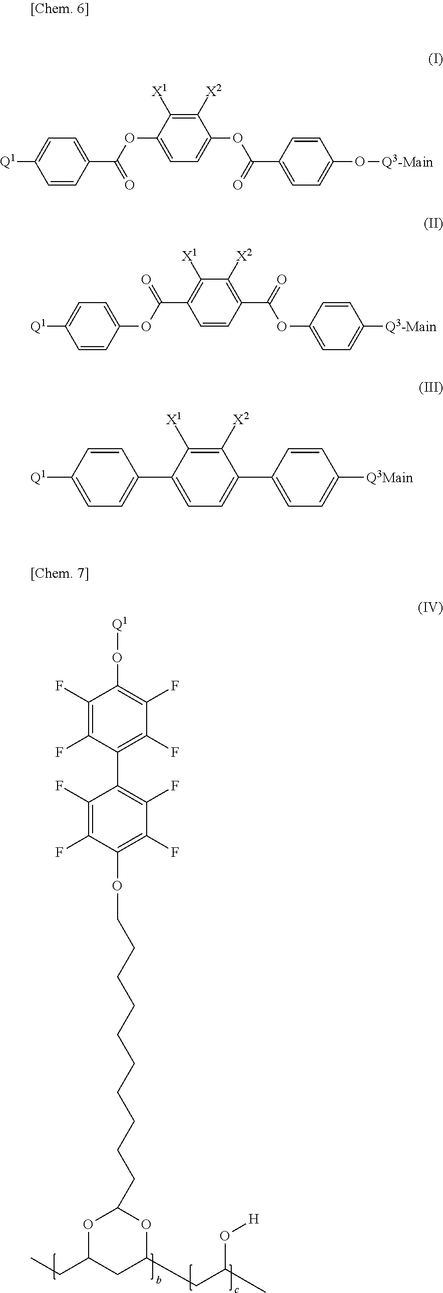

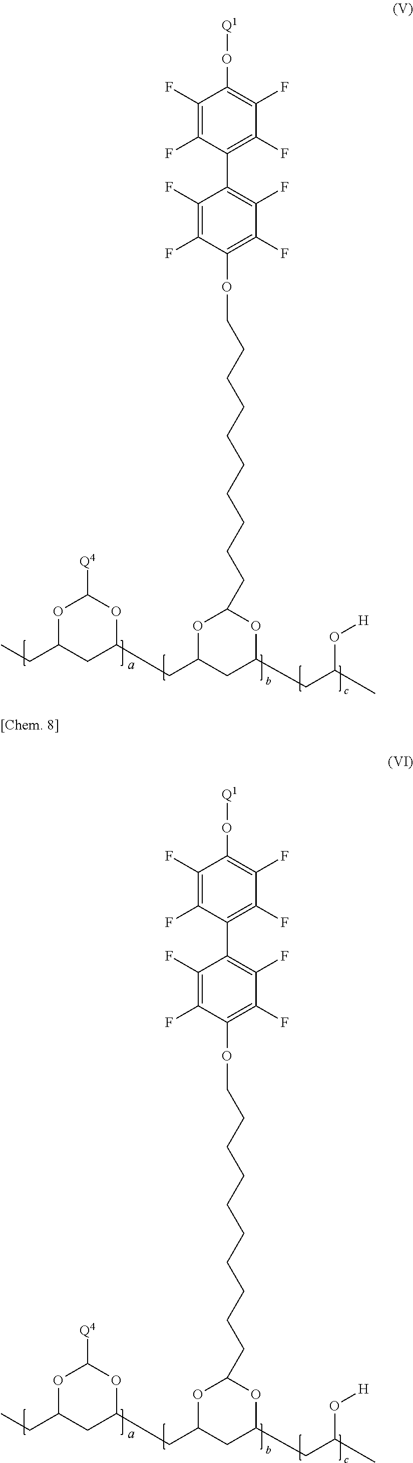

Examples of a macromolecule for vertical alignment containing, in the side chain, a functional group having positive dielectric anisotropy include compounds (VII) to (XVI) shown below.

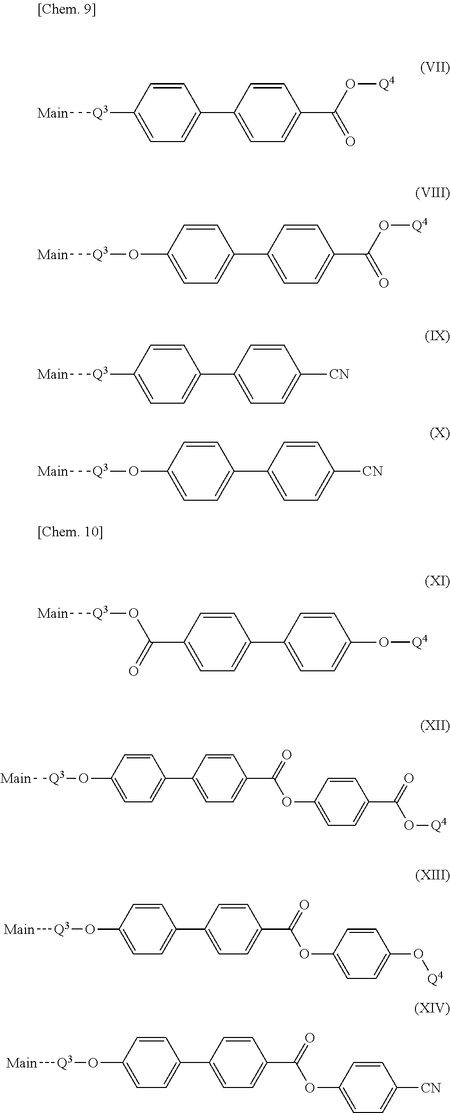

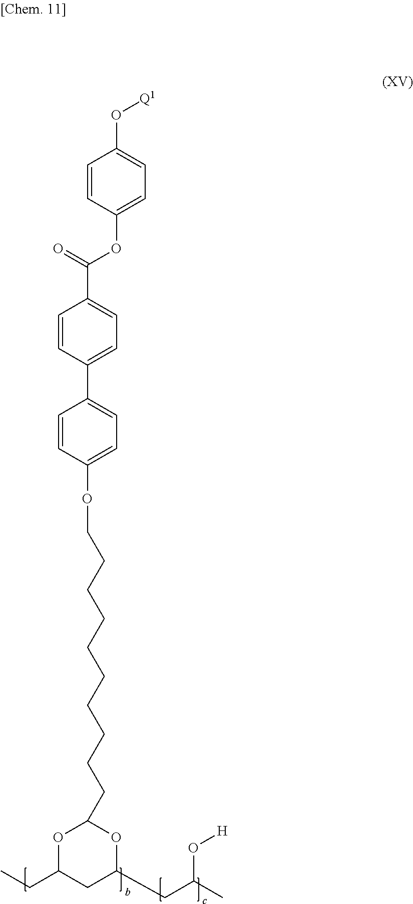

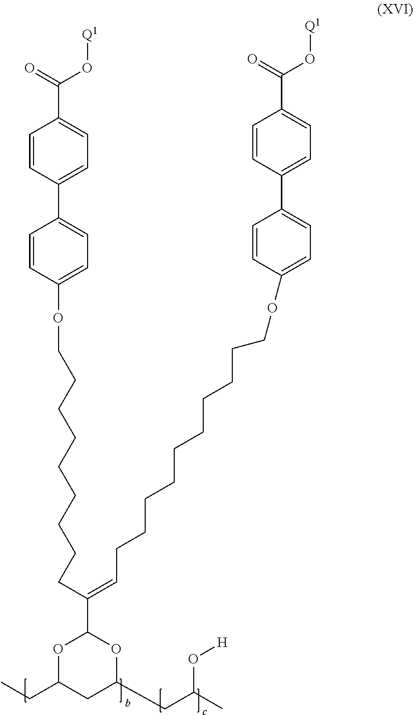

Examples of a macromolecule for horizontal alignment containing, in the side chain, a functional group having positive dielectric anisotropy include compounds (XVII) to (XXXIX) shown below.

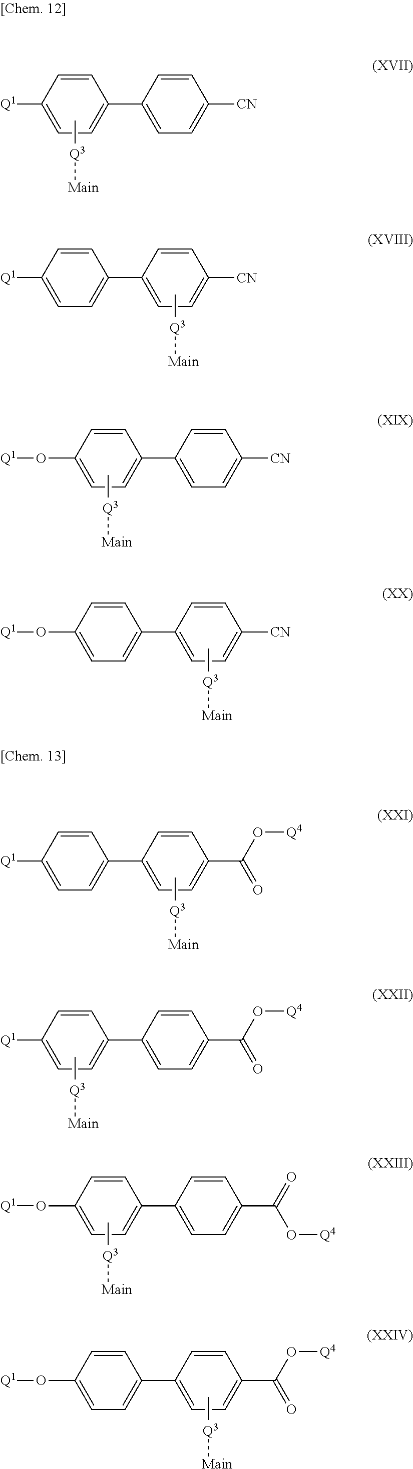

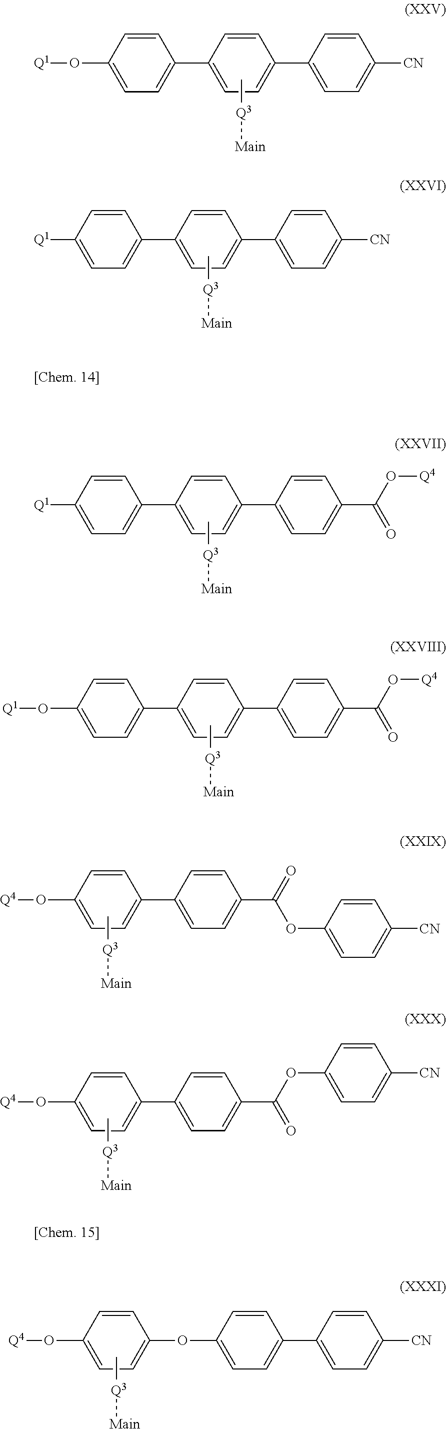

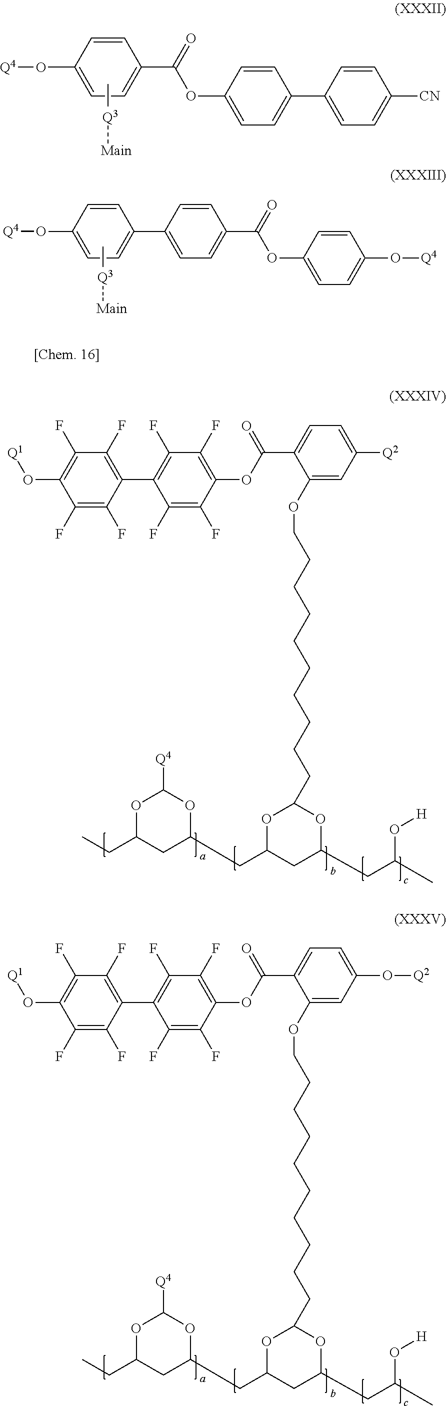

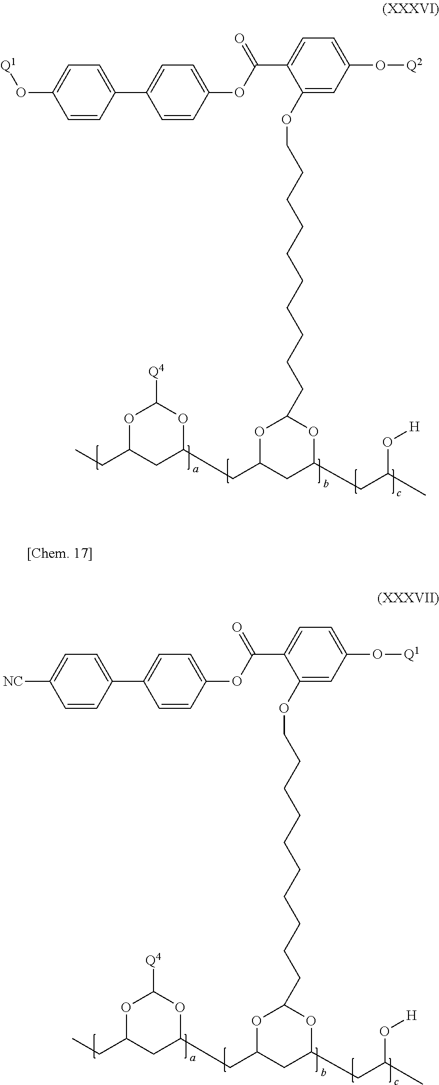

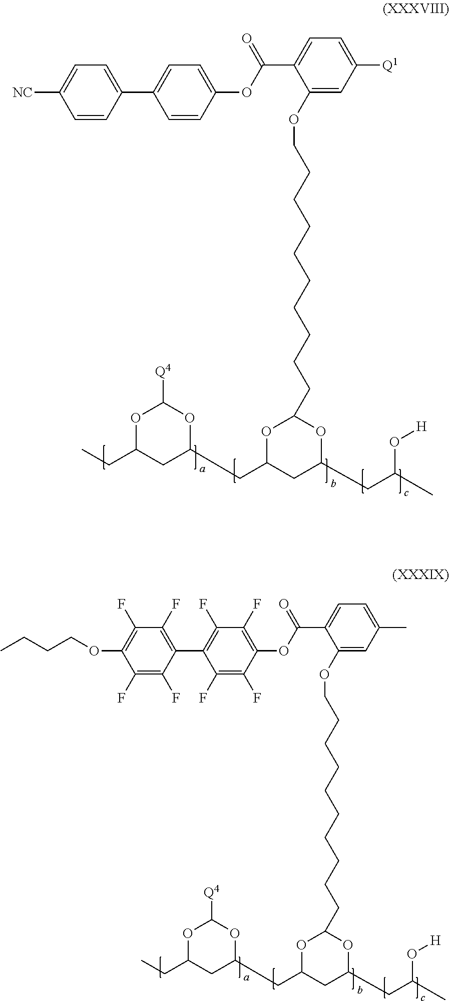

Examples of a macromolecule for horizontal alignment containing, in the side chain, a functional group having negative dielectric anisotropy include compounds (XXXX) to (XXXXXI) shown below.

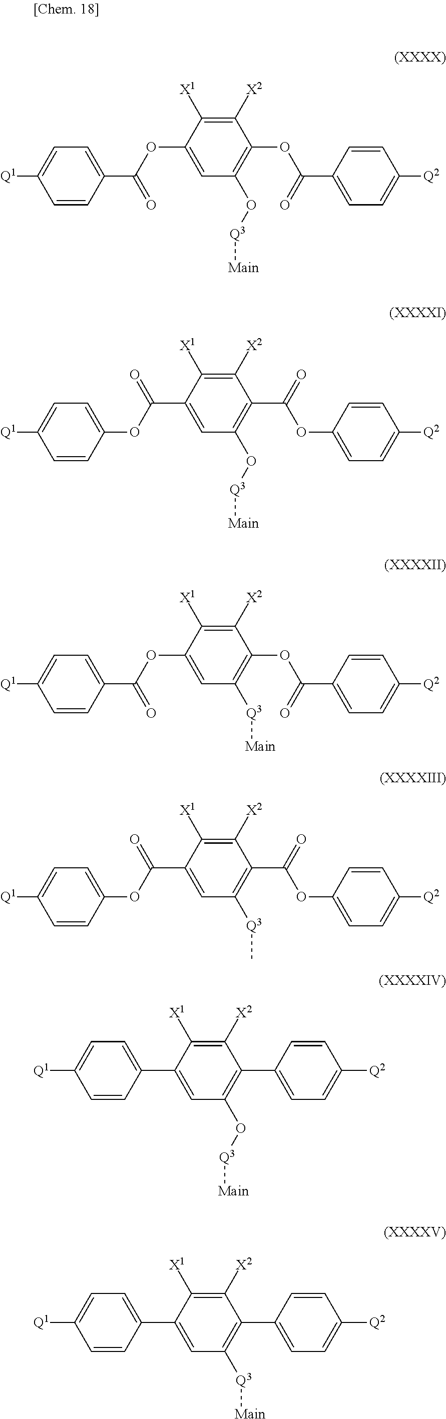

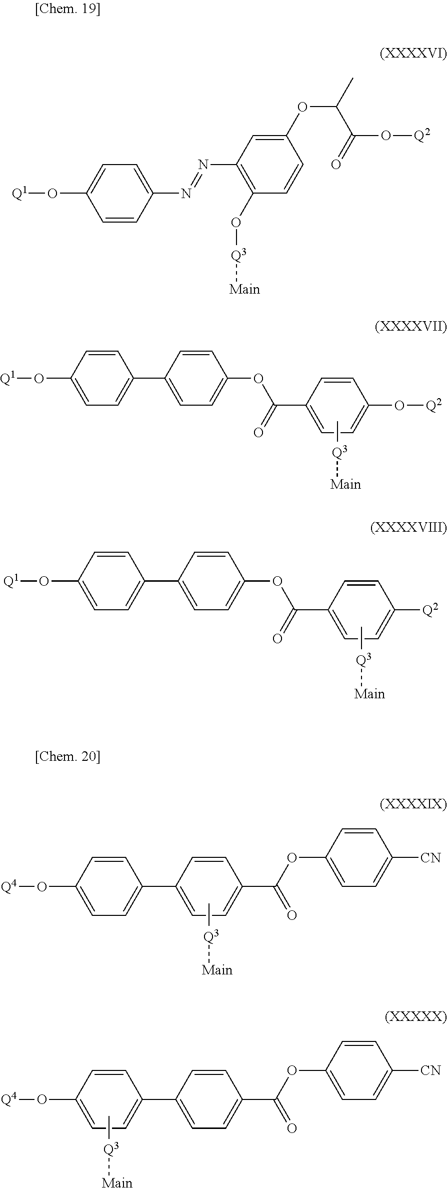

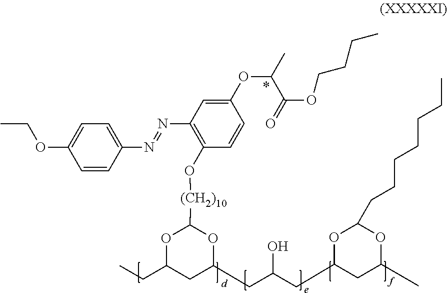

In compounds (I) to (XXXXXI), Q1 and Q2 are the same or different and each represent an aliphatic hydrocarbon group such as an alkyl group, preferably an aliphatic hydrocarbon group of 1 to 20 carbon atoms, such as an alkyl group of 2 to 12 carbon atoms. Q3 represents an aliphatic hydrocarbon group such as an alkyl group, siloxane, an ethylene glycol chain, or any combination thereof. Q3 preferably contains at least 2, more preferably 2 to 20 (e.g., 4 to 20), even more preferably 5 to 20 carbon atoms or heteroatoms. Q4 represents an aliphatic hydrocarbon group such as an alkyl group, preferably having 1 to 20 (e.g., 1 to 5) carbon atoms. X1 and X2 are the same or different and each represent H, F, Cl, CN, or CF3. X3 and X4 are the same or different and each represent F or Cl, preferably F. Main represents part of the main chain of the macromolecule.

The letters a, b, and c each represent a value indicating the degree of polymerization of each monomer unit. In compound (XXXXXI), d, e, and f also each represent a value indicating the degree of polymerization of each monomer unit. The ratio (d+f)/e is in the range of 25/50 to 43/14, preferably greater than 40/20, and, for example, 43/18. The ratio d/f is in the range of 9/1 to 1/9, preferably in the range of 3/1 to 1/3, and, for example, 1/1.

(3) Liquid Crystal Layer

The liquid crystal molecule (liquid crystal material) used to form the liquid crystal layer may be selected from suitable known materials depending on the mode of the liquid crystal display device. The liquid crystal molecule may have positive dielectric anisotropy or negative dielectric anisotropy.

<Method for Manufacturing Liquid Crystal Display Device>

The liquid crystal display device according to the invention is advantageously manufactured by a method including the following steps of:

forming an alignment film on at least one surface of each of a pair of substrates, wherein the alignment film includes a macromolecule containing a functional group having dielectric anisotropy;

arranging the pair of substrates opposite to each other with the alignment film placed inside;

introducing a liquid crystal composition between the pair of substrates, wherein the liquid crystal composition contains a liquid crystal molecule and a polymerizable monomer; and

polymerizing the polymerizable monomer to form a polymer layer.

The alignment film can be formed by applying an alignment agent to the substrate and drying the alignment agent, in which the alignment agent contains the macromolecule containing a functional group having dielectric anisotropy. The substrate may be a conventionally known substrate such as a glass substrate or any of various transparent plastic substrates. Subsequently, the pair of substrates are arranged opposite to each other with the alignment film placed inside, and conventionally known methods may be used to fabricate a liquid crystal display device (liquid crystal cell) to be filled with a liquid crystal material. The alignment film may be optionally subjected to an alignment treatment. The alignment treatment may be a rubbing treatment, a photo-alignment treatment, or the like.

Next, the liquid crystal composition containing the liquid crystal molecule and the polymerizable monomer is introduced and charged into the space between the substrates. The liquid crystal composition-charging method may be, but not limited to, an ODF method, a vacuum injection method, or other conventionally known method.

Subsequently, the polymerizable monomer is polymerized to form the polymer layer. The polymerizable monomer can be polymerized by heating or photoirradiation such as ultraviolet irradiation. The polymerization is preferably performed by photoirradiation. The photoirradiation is usually performed in two separate stages although it may be performed in one stage. In the first stage of the photoirradiation, ultraviolet rays are applied to the liquid crystal layer while a voltage equal to or greater than the threshold for liquid crystal response is applied to the introduced liquid crystal composition. As a result, the polymerizable monomer is polymerized in the vicinity of the alignment film while the orientation of the liquid crystal molecule is tilted, so that a polymer layer is formed in contact with the alignment film. Thus, the polymer layer memorizes the tilt direction of the liquid crystal molecule. Subsequently, in the second stage of photoirradiation, light is applied while no voltage is applied. Thus, the polymerizable monomer remaining in the liquid crystal material is completely polymerized. The polymer layer formed imparts a pretilt angle to the liquid crystal molecule in the vicinity of the alignment film and defines the direction of orientation of the liquid crystal molecule.

When the alignment film has been subjected to an alignment treatment, the polymer layer can be formed by one-stage ultraviolet irradiation. In this case, ultraviolet rays are applied while a voltage lower than the threshold for liquid crystal response is applied to the liquid crystal composition or while no voltage is applied. In this way, a liquid crystal display device having a high VHR and a low rDC is successfully manufactured.

### EXAMPLES

Hereinafter, the invention will be more specifically described with reference to examples, which however are not intended to limit the invention.

### Example 1

### Use of Compound (VIII) to Form Vertical Alignment Film

An alignment film-forming solution containing a macromolecule containing a side chain having positive dielectric anisotropy was applied to each of a pair of glass substrates each having an ITO transparent electrode formed on the surface. The applied solution was pre-baked under conditions at 80° C. and then post-baked under conditions at 200° C. for 60 minutes, so that an alignment film for vertical alignment was formed on the transparent electrode. Compound (VIII) was used as the macromolecule containing a side chain having positive dielectric anisotropy. Subsequently, a seal was applied to one of the glass substrates, and beads were scattered on the other glass substrate. These substrates were then bonded together in such a way that the seal-coated surface and the beads-scattered surface were placed inside.

A liquid crystal composition was prepared containing a liquid crystal molecule having negative dielectric anisotropy and a polymerizable monomer in an amount of 0.3 wt % based on the amount of the liquid crystal molecule. The polymerizable monomer was compound a-1 represented by the following formula:

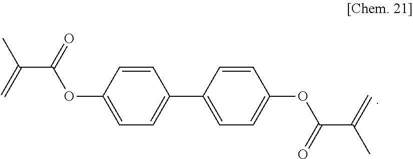 [SMILES: C=C(C)C(=O)Oc1ccc(-c2ccc(OC(=O)C(=C)C)cc2)cc1]

The liquid crystal composition was then injected between the substrates, and the liquid crystal injection port was sealed. MLC-6610 was used as the liquid crystal molecule having negative dielectric anisotropy. Subsequently, the liquid crystal composition layer was irradiated with ultraviolet rays from a black light for 15 minutes while a voltage of 10 V was applied to the liquid crystal composition layer. The liquid crystal composition layer was further irradiated with ultraviolet rays from a black light for 60 minutes while no voltage was applied. Thereby, a polymer layer including a polymer of compound a-1 was formed between the alignment film and the liquid crystal layer, and a liquid crystal cell was obtained.

### Examples 2 and 3

### Use of Compound (VIII) to Form Vertical Alignment Film

Liquid crystal cells were each prepared as in Example 1, except that compound a-2 (Example 2) represented by the following formula:

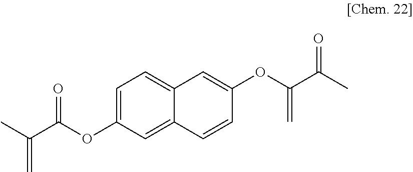 [SMILES: C=C(C)C(=O)Oc1ccc2cc(OC(=C)C(C)=O)ccc2c1]

or compound a-3 (Example 3) represented by the following formula:

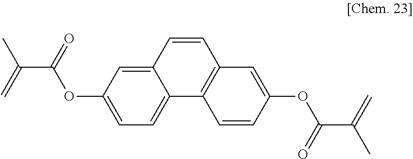 [SMILES: C=C(C)C(=O)Oc1ccc2c(ccc3cc(OC(=O)C(=C)C)ccc32)c1]

was used in an amount of 0.3 wt % based on the amount of the liquid crystal molecule instead of compound a-1.

### Comparative Example 1

A liquid crystal cell was prepared as in Example 1, except that the liquid crystal composition used contained no polymerizable monomer and ultraviolet irradiation was not performed.

### Comparative Example 2

A liquid crystal cell was prepared as in Comparative Example 1, except that the alignment film was formed using a macromolecule containing a side chain having no dielectric anisotropy.

(Evaluation of Voltage Holding Ratio and Residual DC Voltage)

The response time, voltage holding ratio (VHR), and residual DC voltage (rDC) of the liquid crystal cells of Examples 1 to 3 and Comparative Examples 1 and 2 were measured and evaluated by the procedures shown below. Table 1 shows the results.

(1) Response Time

Using Photal 5200 manufactured by Otsuka Electronics Co., Ltd., the rise response time (ms) was measured as the time required for the transmittance to change from 10% to 90% when the voltage applied to the liquid crystal cell was increased from 0.5 V to 6 V. The fall response time (ms) was also measured as the time required for the transmittance to change from 90% to 10% when the voltage applied to the liquid crystal cell was decreased from 6 V to 0.5 V.

(2) VHR

After a pulse voltage of 1 V was applied to the liquid crystal cell, the charge retention for 16.67 milliseconds was measured and used to determine VHR (%). The measurement was performed at 70° C. using LC Material Characteristics Measurement System Model 6254 manufactured by TOYO Corporation.

(3) rDC

After a DC offset voltage of 2 V was applied to the liquid crystal cell for 10 hours, the rDC (mV) of the liquid crystal cell was determined by flicker elimination method.

TABLE 1

| | | | VHR | |
|---|---|---|---|---|
| | Rise response time | Fall response time | (%) | rDC |
| | (ms) | (ms) | 70° C. | (mV) |
| Example 1 | 7.8 | 5.8 | 98.0 | 190 |
| Example 2 | 7.6 | 5.8 | 98.9 | 20 |
| Example 3 | 7.6 | 5.8 | 99.5 | 10 |
| Comparative | 7.8 | 6.0 | 62.1 | 450 |
| Example 1 | | | | |
| Comparative | 47 | 5.7 | 99.1 | 40 |
| Example 2 | | | | |

As shown in Table 1, when a macromolecule containing a side chain having positive dielectric anisotropy and a polymer of compound a-1, compound a-2, or compound a-3 were used to form the alignment film and the polymer layer, respectively, the resulting rise response time was about 7.7 ms (Examples 1 to 3), which was significantly shorter than that of Comparative Example 2 using an alignment film having no dielectric anisotropy, and the resulting VHR and rDC were at least 98% and at most 190 mV, respectively (Examples 1 to 3), which were significantly better than those of Comparative Example 1. In contrast, the liquid crystal cell of Comparative Example 1 had a VHR as low as on the order of 60% and an rDC as high as at least 400 mV.

### Examples 4 to 6

### Use of Compound (VIII) to Form Vertical Alignment Film

Liquid crystal cells were each prepared as in Example 1, except that compound a-4 (Example 4) represented by the following formula:

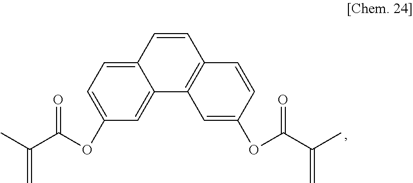 [SMILES: C=C(C)C(=O)Oc1ccc2ccc3ccc(OC(=O)C(=C)C)cc3c2c1]

compound a-5 (Example 5) represented by the following formula:

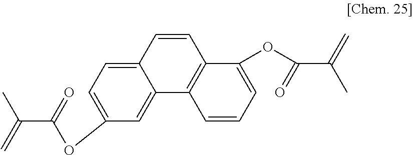 [SMILES: C=C(C)C(=O)Oc1ccc2ccc3c(OC(=O)C(=C)C)cccc3c2c1]

or compound a-6 (Example 6) represented by the following formula:

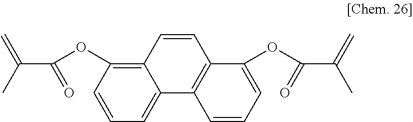 [SMILES: C=C(C)C(=O)Oc1cccc2c1ccc1c(OC(=O)C(=C)C)cccc12]

was used in an amount of 0.3 wt % based on the amount of the liquid crystal molecule instead of compound a-1.

The response time, VHR, and rDC of the liquid crystal cells of Examples 4 to 6 were measured and evaluated in the same way as described above. Table 2 shows the results. Even when the site of substitution on the phenanthrene skeleton by the radically-polymerizable group (methacryloyloxy group) was changed, a short rise response time was obtained, and a VHR of at least 99% and an rDC of at most 20 mV were obtained.

TABLE 2

| | | | VHR | |
|---|---|---|---|---|
| | Rise response time | Fall response time | (%) | rDC |
| | (ms) | (ms) | 70° C. | (mV) |
| Example 4 | 7.7 | 6.1 | 99.3 | −20 |
| Example 5 | 7.9 | 6.1 | 99.3 | −10 |
| Example 6 | 7.6 | 5.8 | 99.4 | −20 |

### Example 7

### Use of Compound (VIII) to Form Vertical Alignment Film

A liquid crystal cell was prepared as in Example 1, except that a polymerizable monomer mixture of compound a-7 (in an amount of 0.1 wt % based on the amount of the liquid crystal molecule) represented by the following formula:

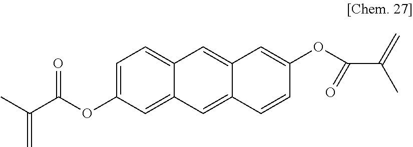 [SMILES: C=C(C)C(=O)Oc1ccc2cc3cc(OC(=O)C(=C)C)ccc3cc2c1]

and compound a-1 shown above (in an amount of 0.2 wt % based on the amount of the liquid crystal molecule) was used instead. The response time, VHR, and rDC of the liquid crystal cell were then measured and evaluated in the same way as described above. Table 3 shows the results. The use of compound a-1 in combination with compound a-7 made it possible to obtain a VHR and an rDC better than those of Example 1 while keeping the rise response time good.

TABLE 3

| | | | VHR | |
|---|---|---|---|---|
| | Rise response time | Fall response time | (%) | rDC |
| | (ms) | (ms) | 70° C. | (mV) |
| Example 7 | 7.8 | 5.9 | 99.5 | −30 |

### Examples 8 to 10

### Use of Compound (XVII) to Form Horizontal Alignment Film

Liquid crystal cells were each prepared as in Example 1, 2, or 3, except that a liquid crystal molecule having positive dielectric anisotropy was used instead, together with compound a-1 (Example 8), compound a-2 (Example 9), or compound a-3 (Example 10) as the polymerizable monomer as in Example 1, 2, or 3. ZLI-4792 was used as the liquid crystal molecule having positive dielectric anisotropy. Compound (XVII) was used as the macromolecule containing a side chain having positive dielectric anisotropy.

### Comparative Examples 3 and 4

Liquid crystal cells were each prepared as in Comparative Example 1 or 2, except that the liquid crystal molecule having positive dielectric anisotropy was used instead and compound (XVII) was used instead as the macromolecule containing a side chain having positive dielectric anisotropy.

The response time, VHR, and rDC of the liquid crystal cells of Examples 8 to 10 and Comparative Examples 3 and 4 were measured and evaluated in the same way as described above. Table 4 shows the results. Even when liquid crystal molecule having positive dielectric anisotropy was used, the rise response time was successfully reduced as compared to the case of Comparative Example 4 where the alignment film used had no dielectric anisotropy, and the resulting VHR and rDC were at least 99% and at most 40 mV, respectively, which were significantly better than those of Comparative Example 3. In contrast, the liquid crystal cell of Comparative Example 3 had a VHR as low as on the order of 75% and an rDC as high as at least 100 mV.

TABLE 4

| | | | VHR | |
|---|---|---|---|---|
| | Rise response time | Fall response time | (%) | rDC |
| | (ms) | (ms) | 70° C. | (mV) |
| Example 8 | 6.4 | 5.5 | 99.0 | 40 |
| Example 9 | 6.3 | 5.2 | 99.5 | 10 |
| Example 10 | 6.1 | 5.4 | 99.5 | 0 |
| Comparative | 6.3 | 5.2 | 75.5 | 120 |
| Example 3 | | | | |
| Comparative | 9.2 | 5.2 | 99.5 | 10 |
| Example 4 | | | | |

### Examples 11 to 13

### Use of Compound (I) to Form Vertical Alignment Film

Liquid crystal cells were each prepared as in Example 1, 2, or 3, except that a macromolecule containing a side chain having negative dielectric anisotropy was used to form the alignment film, together with compound a-1 (Example 11), compound a-2 (Example 12), or compound a-3 (Example 13) used as the polymerizable monomer as in Example 1, 2, or 3. Compound (I) was used as the macromolecule containing a side chain having negative dielectric anisotropy.

### Comparative Example 5

A liquid crystal cell was prepared as in Comparative Example 1, except that the alignment film was formed using a macromolecule containing a side chain having negative dielectric anisotropy.

The response time, VHR, and rDC of the liquid crystal cells of Examples 11 to 13 and Comparative Example 5 were measured and evaluated in the same way as described above. Table 5 shows the results. Even when an alignment film containing a side chain having negative dielectric anisotropy was used, the resulting rise response time was about 8.8 ms, which was significantly shorter than that of Comparative Example 2 using an alignment film having no dielectric anisotropy, and the resulting VHR and rDC were at least 98% and at most 160 mV, respectively, which were significantly better than those of Comparative Example 5. In contrast, the liquid crystal cell of Comparative Example 5 had a VHR as low as on the order of 60% and an rDC as high as at least 400 mV.

TABLE 5

| | | | VHR | |
|---|---|---|---|---|
| | Rise response time | Fall response time | (%) | rDC |
| | (ms) | (ms) | 70° C. | (mV) |
| Example 11 | 9.2 | 5.5 | 98.0 | 160 |
| Example 12 | 8.8 | 5.2 | 99.1 | 30 |
| Example 13 | 8.4 | 5.4 | 99.5 | 0 |
| Comparative | 8.8 | 5.5 | 68.2 | 400 |
| Example 5 | | | | |
| Comparative | 47 | 5.7 | 99.1 | 40 |
| Example 2 | | | | |

### Example 14

### Use of Compound (VIII) to Form Vertical Alignment Film

An alignment film-forming solution containing a macromolecule containing a side chain having positive dielectric anisotropy was applied to each of a pair of glass substrates each having an ITO transparent electrode formed on the surface. The applied solution was pre-baked under conditions at 80° C. and then post-baked under conditions at 200° C. for 60 minutes, so that an alignment film for vertical alignment was formed on the transparent electrode. The macromolecule used, containing a side chain having positive dielectric anisotropy, was the same as in Example 1. Subsequently, a seal was applied to one of the glass substrates, and beads were scattered on the other glass substrate. These substrates were then bonded together in such a way that the seal-coated surface and the beads-scattered surface were placed inside.

A liquid crystal composition was prepared containing liquid crystal molecule having negative dielectric anisotropy, compound b-1 (in an amount of 0.05 wt % based on the amount of the liquid crystal molecule) as a polymerizable monomer represented by the following formula:

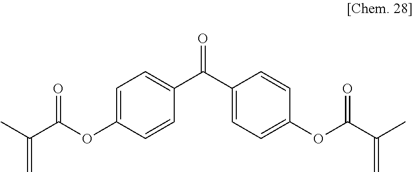 [SMILES: C=C(C)C(=O)Oc1ccc(C(=O)c2ccc(OC(=O)C(=C)C)cc2)cc1]

and compound a-1 shown above (in an amount of 0.3 wt % based on the amount of the liquid crystal molecule) as another polymerizable monomer. The liquid crystal composition was then injected between the substrates, and the liquid crystal injection port was sealed. The liquid crystal molecule used, having negative dielectric anisotropy, was the same as in Example 1. Subsequently, the liquid crystal composition layer was irradiated with ultraviolet rays from a black light for 15 minutes while a voltage of 10 V was applied to the liquid crystal composition layer. The liquid crystal composition layer was further irradiated with ultraviolet rays from a black light for 30 minutes while no voltage was applied. Thereby, a polymer layer was formed between the alignment film and the liquid crystal layer, and a liquid crystal cell was obtained.

### Example 15

### Use of Compound (VIII) to Form Vertical Alignment Film

A liquid crystal cell was prepared as in Example 14, except that a polymerizable monomer mixture of compound b-1 (in an amount of 0.05 wt % based on the amount of the liquid crystal molecule) and compound a-3 shown above (in an amount of 0.3 wt % based on the amount of the liquid crystal molecule) was used instead.

### Examples 16 and 17

### Use of Compound (VIII) to Form Vertical Alignment Film

Liquid crystal cells were each prepared as in Example 14, except that compound a-1 shown above alone (in an amount of 0.3 wt % based on the amount of the liquid crystal molecule) (Example 16) or compound a-3 shown above alone (in an amount of 0.3 wt % based on the amount of the liquid crystal molecule) (Example 17) was used instead as the polymerizable monomer. These examples were the same as Examples 1 and 3, respectively, except that the time of black light irradiation with no voltage applied was changed from 60 minutes to 30 minutes.

The response time, VHR, and rDC of the liquid crystal cells of Examples 14 to 17 were measured and evaluated in the same way as described above. Table 6 shows the results.

TABLE 6

| | | | VHR | |
|---|---|---|---|---|
| | Rise response time | Fall response time | (%) | rDC |
| | (ms) | (ms) | 70° C. | (mV) |
| Example 14 | 7.8 | 5.9 | 99.5 | 20 |
| Example 15 | 7.6 | 6.0 | 99.5 | 0 |
| Example 16 | 7.8 | 5.8 | 98.3 | 230 |
| Example 17 | 7.6 | 5.9 | 99.5 | 40 |
| Comparative | 7.8 | 6.0 | 62.1 | 450 |
| Example 1 | | | | |
| Comparative | 47 | 5.7 | 99.1 | 40 |
| Example 2 | | | | |

As shown in Table 6, when a macromolecule containing a side chain having positive dielectric anisotropy was used to form an alignment film and at least one of compound b-1, compound a-1, and compound a-3 was used as a polymerizable monomer (Examples 14 to 17), the resulting rise response time was about 7.7 ms, which was significantly shorter than that of Comparative Example 2 using an alignment film having no dielectric anisotropy, and the resulting VHR and rDC were at least 98% and at most 230 mV, respectively, which were significantly better than those of Comparative Example 1. When compound b-1 capable of undergoing a hydrogen abstraction reaction to produce a ketyl radical was used (Examples 14 and 15), the resulting VHR and rDC were 99.5% and at most 20 mV, respectively, which were more improved than those in the case where compound b-1 was not used, while the short rise response time was maintained. In Examples 14 and 15, the time of black light irradiation with no voltage applied was reduced to 30 minutes. Nevertheless, when compound b-1 capable of undergoing a hydrogen abstraction reaction to produce a ketyl radical was used, the resulting VHR or rDC was more improved than that of Example 1 or 3 where the time of black light irradiation was 60 minutes. This shows that the use of the compound capable of undergoing a hydrogen abstraction reaction to produce a ketyl radical makes it possible to shorten the process of forming the polymer layer.

### Examples 18 to 21

### Use of Compound (I) to Form Vertical Alignment Film

Liquid crystal cells were prepared as in Examples 14 to 17, respectively, except that a macromolecule containing a side chain having negative dielectric anisotropy was used to form the alignment film. The macromolecule used, containing a side chain having negative dielectric anisotropy, was the same as in Example 11. The response time, VHR, and rDC of the liquid crystal cells of Examples 18 to 21 were measured and evaluated in the same way as described above. Table 7 shows the results. Even when an alignment film containing a side chain having negative dielectric anisotropy was used, the resulting rise response time was at most 8.8 ms, which was significantly shorter than that of Comparative Example 2 using an alignment film having no dielectric anisotropy, and the resulting VHR and rDC were at least 98% and at most 220 mV, respectively, which were significantly better than those of Comparative Example 5. When compound b-1 capable of undergoing a hydrogen abstraction reaction to produce a ketyl radical was used, the resulting VHR and rDC were 99.5% and 10 mV, respectively (Examples 18 and 19), which were more improved than those in the case where compound b-1 was not used, while the short rise response time was maintained. As in Examples 14 and 15, it was possible to shorten the process of forming the polymer layer.

TABLE 7

| | | | VHR | |
|---|---|---|---|---|
| | Rise response time | Fall response time | (%) | rDC |
| | (ms) | (ms) | 70° C. | (mV) |
| Example 18 | 8.8 | 5.6 | 99.5 | 10 |
| Example 19 | 8.5 | 5.8 | 99.5 | 10 |
| Example 20 | 8.7 | 5.7 | 98.4 | 220 |
| Example 21 | 8.7 | 5.5 | 99.3 | 30 |
| Comparative | 8.8 | 5.5 | 68.2 | 400 |
| Example 5 | | | | |

### Examples 22 and 23

### Use of Compound (VIII) to Form Vertical Alignment Film

Liquid crystal cells were each prepared as in Example 14, except that a polymerizable monomer mixture of compound b-2 (in an amount of 0.05 wt % based on the amount of the liquid crystal molecule) represented by the following formula:

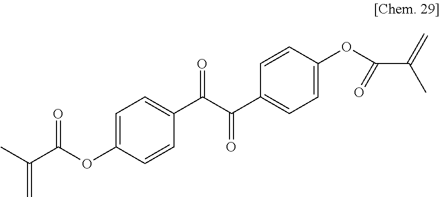 [SMILES: C=C(C)C(=O)Oc1ccc(C(=O)C(=O)c2ccc(OC(=O)C(=C)C)cc2)cc1]

and compound a-1 shown above (in an amount of 0.3 wt % based on the amount of liquid crystal molecule) was used instead (Example 22), or a polymerizable monomer mixture of compound b-2 shown above (in an amount of 0.05 wt % based on the amount of the liquid crystal molecule) and compound a-3 shown above (in an amount of 0.3 wt % based on the amount of liquid crystal molecule) was used instead (Example 23).

The response time, VHR, and rDC of the liquid crystal cells of Examples 22 and 23 were measured and evaluated in the same way as described above. Table 8 shows the results. Even when compound b-2 was used instead of compound b-1, a short rise response time was obtained, and a VHR of 99.5% and an rDC of at most 30 mV were also obtained, so that the same advantageous effect was obtained as in the case using compound b-1.

TABLE 8

| | | | VHR | |
|---|---|---|---|---|
| | Rise response time | Fall response time | (%) | rDC |
| | (ms) | (ms) | 70° C. | (mV) |
| Example 22 | 7.9 | 5.5 | 99.5 | 30 |
| Example 23 | 7.7 | 5.9 | 99.5 | 20 |

### Examples 24 and 25

### Use of Compound (I) to Form Vertical Alignment Film

Liquid crystal cells were each prepared as in Example 18, except that a polymerizable monomer mixture of compound b-2 shown above (in an amount of 0.05 wt % based on the amount of the liquid crystal molecule) and compound a-1 shown above (in an amount of 0.3 wt % based on the amount of liquid crystal molecule) was used instead (Example 24), or a polymerizable monomer mixture of compound b-2 shown above (in an amount of 0.05 wt % based on the amount of the liquid crystal molecule) and compound a-3 shown above (in an amount of 0.3 wt % based on the amount of liquid crystal molecule) was used instead (Example 25).

The response time, VHR, and rDC of the liquid crystal cells of Examples 24 and 25 were measured and evaluated in the same way as described above. Table 9 shows the results. As in Examples 22 and 23, even when compound b-2 was used instead of compound b-1, a short rise response time was obtained, and a VHR of 99.5% and an rDC of at most 10 mV were also obtained, so that the same advantageous effect was obtained as in the case using compound b-1.

TABLE 9

| | | | VHR | |
|---|---|---|---|---|
| | Rise response time | Fall response time | (%) | rDC |
| | (ms) | (ms) | 70° C. | (mV) |
| Example 24 | 8.8 | 5.6 | 99.5 | 10 |
| Example 25 | 8.9 | 5.5 | 99.5 | 0 |

### Example 26

### Use of Compound (VIII) to Form Vertical Alignment Film

An alignment film-forming solution containing a macromolecule containing a side chain having positive dielectric anisotropy was applied to each of a pair of glass substrates each having an ITO transparent electrode formed on the surface. The applied solution was pre-baked under conditions at 80° C. and then post-baked under conditions at 200° C. for 60 minutes, so that an alignment film for vertical alignment was formed on the transparent electrode. The macromolecule used, containing a side chain having positive dielectric anisotropy, was the same as in Example 1. Subsequently, a seal was applied to one of the glass substrates, and beads were scattered on the other glass substrate. These substrates were then bonded together in such a way that the seal-coated surface and the beads-scattered surface were placed inside.

A liquid crystal composition was prepared containing a liquid crystal molecule having negative dielectric anisotropy, compound c-1 (in an amount of 0.05 wt % based on the amount of the liquid crystal molecule) as a polymerizable monomer represented by the following formula:

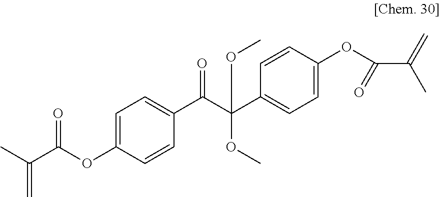 [SMILES: C=C(C)C(=O)Oc1ccc(C(=O)C(OC)(OC)c2ccc(OC(=O)C(=C)C)cc2)cc1]

and compound a-1 shown above (in an amount of 0.3 wt % based on the amount of the liquid crystal molecule) as another polymerizable monomer. The liquid crystal composition was then injected between the substrates, and the liquid crystal injection port was sealed. The liquid crystal molecule used, having negative dielectric anisotropy, was the same as in Example 1. Subsequently, the liquid crystal composition layer was irradiated with ultraviolet rays from a black light for 15 minutes while a voltage of 10 V was applied to the liquid crystal composition layer. The liquid crystal composition layer was further irradiated with ultraviolet rays from a black light for 30 minutes while no voltage was applied. Thereby, a polymer layer was formed between the alignment film and the liquid crystal layer, and a liquid crystal cell was obtained.

### Example 27

### Use of Compound (VIII) to Form Vertical Alignment Film

A liquid crystal cell was prepared as in Example 26, except that a polymerizable monomer mixture of compound c-1 (in an amount of 0.05 wt % based on the amount of the liquid crystal molecule) and compound a-3 shown above (in an amount of 0.3 wt % based on the amount of the liquid crystal molecule) was used instead.

The response time, VHR, and rDC of the liquid crystal cells of Examples 26 and 27 were measured and evaluated in the same way as described above. Table 10 shows the results.

TABLE 10

| | | | VHR | |
|---|---|---|---|---|
| | Rise response time | Fall response time | (%) | rDC |
| | (ms) | (ms) | 70° C. | (mV) |
| Example 26 | 7.5 | 5.9 | 99.5 | 0 |
| Example 27 | 7.5 | 5.9 | 99.5 | 0 |
| Example 16 | 7.8 | 5.8 | 98.3 | 230 |
| Example 17 | 7.6 | 5.9 | 99.5 | 40 |
| Comparative | 7.8 | 6.0 | 62.1 | 450 |
| Example 1 | | | | |
| Comparative | 47 | 5.7 | 99.1 | 40 |
| Example 2 | | | | |

As shown in Table 10, when a macromolecule containing a side chain having positive dielectric anisotropy was used to form an alignment film and at least one of compound c-1, compound a-1, and compound a-3 was used as a polymerizable monomer (Examples 26 and 27 and Examples 16 and 17), the resulting rise response time was about 7.7 ms, which was significantly shorter than that of Comparative Example 2 using an alignment film having no dielectric anisotropy, and the resulting VHR and rDC were at least 98% and at most 230 mV, respectively, which were significantly better than those of Comparative Example 1. When compound c-1 capable of undergoing a self-cleavage reaction to produce radicals was used (Examples 26 and 27), the resulting VHR and rDC were 99.5% and 0 mV, respectively, which were more improved than those in the case where compound c-1 was not used, while the short rise response time was maintained. In Examples 26 and 27, the time of black light irradiation with no voltage applied was reduced to 30 minutes. Nevertheless, when compound c-1 capable of undergoing a self-cleavage reaction to produce radicals was used, the resulting VHR or rDC was more improved than that of Example 1 or 3 where the time of black light irradiation was 60 minutes. This shows that the use of the compound capable of undergoing a self-cleavage reaction to produce radicals makes it possible to shorten the process of forming the polymer layer.

### Examples 28 and 29

### Use of Compound (I) to Form Vertical Alignment Film

Liquid crystal cells were prepared as in Examples 26 and 27, respectively, except that a macromolecule containing a side chain having negative dielectric anisotropy was used to form the alignment film. The macromolecule used, containing a side chain having negative dielectric anisotropy, was the same as in Example 11.

The response time, VHR, and rDC of the liquid crystal cells of Examples 28 and 29 were measured and evaluated in the same way as described above. Table 11 shows the results. Even when an alignment film containing a side chain having negative dielectric anisotropy was used, the resulting rise response time was at most 8.7 ms, which was significantly shorter than that of Comparative Example 2 using an alignment film having no dielectric anisotropy. In addition, when compound c-1 capable of undergoing a self-cleavage reaction to produce radicals was used, the resulting VHR and rDC were 99.5% and 0 mV, respectively, which were more improved than those of Examples 20 and 21 where compound c-1 was not used, while the short rise response time was maintained. As in Examples 26 and 27, it was possible to shorten the process of forming the polymer layer.

TABLE 11

| | | | VHR | |
|---|---|---|---|---|
| | Rise response time | Fall response time | (%) | rDC |
| | (ms) | (ms) | 70° C. | (mV) |
| Example 28 | 8.5 | 5.7 | 99.5 | 0 |
| Example 29 | 8.5 | 5.6 | 99.5 | 0 |
| Example 20 | 8.7 | 5.7 | 98.4 | 220 |
| Example 21 | 8.7 | 5.5 | 99.3 | 30 |
| Comparative | 8.8 | 5.5 | 68.2 | 400 |
| Example 5 | | | | |

### Examples 30 to 33

### Use of Compound (XVII) to Form Horizontal Alignment Film

Liquid crystal cells were prepared (Examples 30 and 31) as in Examples 26 and 27, respectively, except that liquid crystal molecule having positive dielectric anisotropy was used instead and compound (XVII) was used as the macromolecule containing a side chain having positive dielectric anisotropy. Liquid crystal cells were also prepared (Examples 32 and 33) as in Examples 16 and 17, respectively, except that a liquid crystal molecule having positive dielectric anisotropy was used instead. The liquid crystal molecule used, having positive dielectric anisotropy, was the same as in Example 8.

The response time, VHR, and rDC of the liquid crystal cells of Examples 30 to 33 were measured and evaluated in the same way as described above. Table 12 shows the results. Even when a liquid crystal molecule having positive dielectric anisotropy was used, the rise response time was successfully reduced as compared to the case of Comparative Example 4 where the alignment film used had no dielectric anisotropy, and the resulting VHR and rDC were at least 99% and at most 10 mV, respectively, which were significantly better than those of Comparative Example 3. In addition, when compound c-1 capable of undergoing a self-cleavage reaction to produce radicals was used, the resulting VHR and rDC were 99.5% and 0 mV, respectively, which were more improved than those of Examples 32 and 33 where compound c-1 was not used, while the short rise response time was maintained.

TABLE 12

| | | | VHR | |
|---|---|---|---|---|
| | Rise response time | Fall response time | (%) | rDC |
| | (ms) | (ms) | 70° C. | (mV) |
| Example 30 | 6.4 | 5.3 | 99.5 | 0 |
| Example 31 | 6.4 | 5.2 | 99.5 | 0 |
| Example 32 | 6.4 | 5.5 | 99.3 | 10 |
| Example 33 | 6.1 | 5.4 | 99.5 | 0 |
| Comparative | 6.3 | 5.2 | 75.5 | 120 |
| Example 3 | | | | |
| Comparative | 9.2 | 5.2 | 99.5 | 10 |
| Example 4 | | | | |

### Examples 34 to 37 and Comparative Example 6

### Use of Compound (XXXX) to Form Horizontal Alignment Film

Liquid crystal cells were prepared (Examples 34 to 37) as in Examples 30 to 33, respectively, except that a macromolecule containing a side chain having negative dielectric anisotropy was used to form the alignment film. A liquid crystal cell was also prepared (Comparative Example 6) as in Comparative Example 3, except that a macromolecule containing a side chain having negative dielectric anisotropy was used to form the alignment film. Compound (XXXX) was used as the macromolecule containing a side chain having negative dielectric anisotropy.

The response time, VHR, and rDC of the liquid crystal cells of Examples 34 to 37 and Comparative Example 6 were measured and evaluated in the same way as described above. Table 13 shows the results. Even when an alignment film containing a side chain having negative dielectric anisotropy was used, the rise response time was successfully reduced as compared to the case of Comparative Example 4 where the alignment film used had no dielectric anisotropy, and the resulting VHR and rDC were at least 99% and at most 30 mV, respectively, which were significantly better than those of Comparative Example 6. In addition, when compound c-1 capable of undergoing a self-cleavage reaction to produce radicals was used, the resulting VHR and rDC were 99.5% and 0 mV, respectively, which were more improved than those of Examples 36 where compound c-1 was not used, while the short rise response time was maintained.

TABLE 13

| | | | VHR | |
|---|---|---|---|---|
| | Rise response time | Fall response time | (%) | rDC |
| | (ms) | (ms) | 70° C. | (mV) |
| Example 34 | 8.4 | 5.1 | 99.5 | 0 |
| Example 35 | 8.4 | 5.1 | 99.5 | 0 |
| Example 36 | 8.5 | 5.2 | 99.3 | 30 |
| Example 37 | 8.5 | 5.3 | 99.5 | 0 |
| Comparative | 8.4 | 5.0 | 68.5 | 150 |
| Example 6 | | | | |

### Reference Example

### Factors for Short Rise Response Time

As shown above, liquid crystal display devices can have a short rise response time when they have an alignment film including a macromolecule containing a functional group with dielectric anisotropy in the side chain and also have a polymer layer between the alignment film and the liquid crystal layer. If the response of the liquid crystal molecule is induced by the response of the side chain of the alignment film to an electric field so that a short rise response time is achieved, the alignment film must be in contact with the liquid crystal molecule. In fact, however, as shown above, a short rise response time is obtained even when a polymer layer is formed between the alignment film and the liquid crystal layer so that the alignment film is at least partially not in contact with the liquid crystal molecule. Therefore, a possible cause of such a result was considered to be that the anchoring strength would be reduced by the use of the alignment film containing a side chain having dielectric anisotropy so that a short rise response time could be obtained. Thus, the anchoring strength was evaluated according to the following procedure.

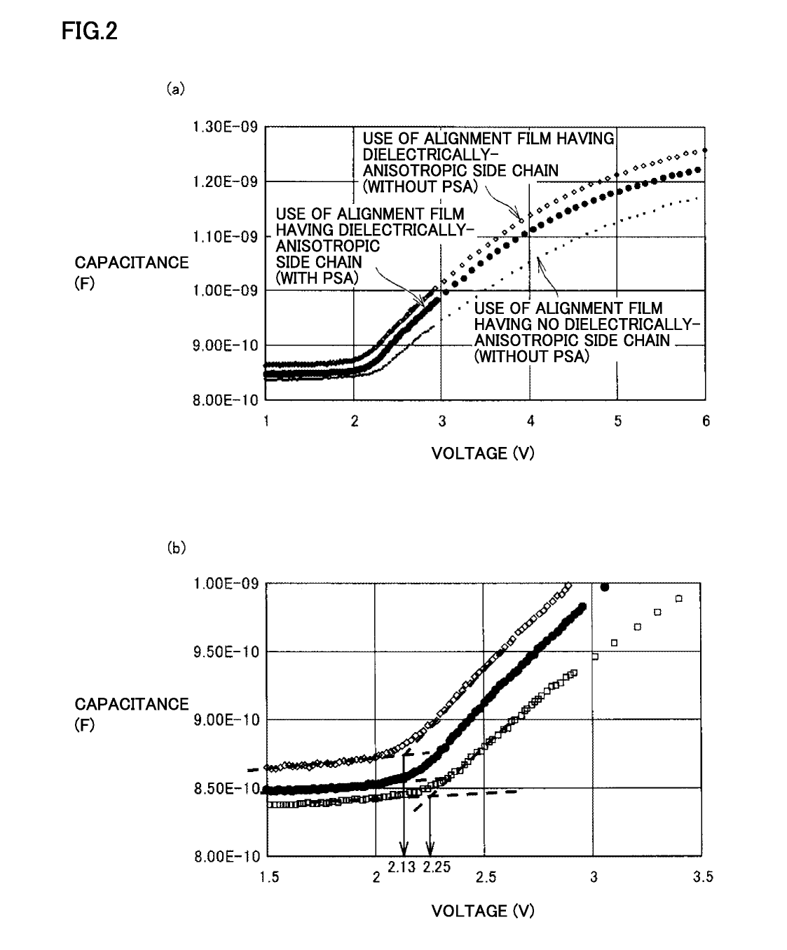

The capacitance-voltage characteristics were measured for the liquid crystal cells of Example 26 (having a dielectrically-anisotropic alignment film and a polymer layer), Comparative Example 1 (having a dielectrically-anisotropic alignment film but no polymer layer), and Comparative Example 2 (having an alignment film with no dielectric anisotropy but not having any polymer layer). FIG. 2 shows the results. In FIG. 2, “with PSA” means the presence of the polymer layer, and “without PSA” means the absence of the polymer layer.

The threshold voltage Vₜₕ in the capacitance-voltage characteristics of FIG. 2 was used to calculate the polar angle anchoring energy (anchoring strength) A (J/m2) from the following formula:

$$A = \frac{{V}_{th}}{d} \sqrt{- {ɛ}_{0} Δɛ {K}_{3}} tan ( \frac{{V}_{th}}{2} \sqrt{\frac{- {ɛ}_{0} Δɛ}{{K}_{3}}} ) \qquad [ Math . 1 ]$$

wherein d, ∈0, Δ∈, and K3 represent the thickness of the liquid crystal layer, the dielectric constant of vacuum, the dielectric anisotropy, and the bend elastic constant, respectively.

As a result, the anchoring strength was 5.1×10⁻⁵ J/m², 5.1×10⁻⁵ J/m², and 8.8×10⁻⁵ J/m², respectively, for Example 26 and Comparative Examples 1 and 2. It has therefore been found that the rise response time decreases with decreasing anchoring strength and that as long as an alignment film containing a side chain having dielectric anisotropy is used, the anchoring strength does not change depending on whether or not a polymer layer exists. This shows that a reduction in the anchoring strength is the cause of the short rise response time that is achieved using the alignment film containing a side chain having dielectric anisotropy, regardless of whether or not the polymer layer exists.

### REFERENCE SIGNS LIST

In the drawings, reference numeral 10 represents a liquid crystal molecule, 21 a macromolecule used to form an alignment film, 22 a side chain of the macromolecule, 23 a functional group having dielectric anisotropy, and 30 a polymer used to form a polymer layer.

1-29. (canceled)

30. A liquid crystal display device, comprising:
a pair of substrates;
a liquid crystal layer that is disposed between said pair of substrates and comprises a liquid crystal molecule;
an alignment film that is disposed between each of said pair of substrates and said liquid crystal layer and comprises a macromolecule containing a functional group having dielectric anisotropy; and
a polymer layer that is disposed between said alignment film and said liquid crystal layer and comprises a polymer of a polymerizable monomer.

31. The liquid crystal display device according to claim 30, wherein said polymerizable monomer includes at least one polymerizable monomer represented by formula (1):
P1-A1-(Z1-A2)n-P2 (1)
wherein
P1 and P2 are the same or different and each represent an acryloyloxy, methacryloyloxy, acryloylamino, methacryloylamino, vinyl, or vinyloxy group,
A1 and A2 are the same or different and each represent a 1,4-phenylene, 4,4′-biphenylene, naphthalene-2,6-diyl, anthracene-2,6-diyl, phenanthrene-2,7-diyl, phenanthrene-3,6-diyl, phenanthrene-1,6-diyl, or phenanthrene-1,8-diyl group, at least one hydrogen atom in A1 and A2 may be substituted with a halogen atom or a methyl group,
Z1 represents COO, OCO, O, CO, NHCO, CONH, or S, or represents a direct bond between A1 and A2 or between A2 and A2, and
n is 0, 1, or 2.

32. The liquid crystal display device according to claim 31, wherein in formula (1), P1 and P2 are the same or different and each represent an acryloyloxy, methacryloyloxy, acryloylamino, or methacryloylamino group.

33. The liquid crystal display device according to claim 31, wherein in formula (1), P1 and P2 are the same or different and each represent an acryloyloxy or methacryloyloxy group, A1 represents a phenanthrene-2,7-diyl group, and n is 0.

34. The liquid crystal display device according to claim 30, wherein said polymerizable monomer includes a compound having a structure capable of undergoing a photoirradiation-induced hydrogen abstraction reaction to produce a ketyl radical.

35. The liquid crystal display device according to claim 34, wherein said compound having a structure capable of undergoing a photoirradiation-induced hydrogen abstraction reaction to produce a ketyl radical includes at least one polymerizable monomer represented by formula (2): 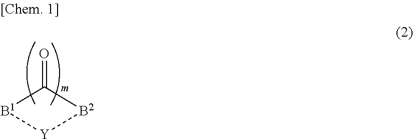
wherein
B1 and B2 are the same or different and each represent a benzene ring, a biphenyl ring, or a linear or branched alkyl or alkenyl group of 1 to 12 carbon atoms, at least one of B1 and B2 represents a benzene ring or a biphenyl ring, and at least one of B1 and B2 contains an -Sp1-P3 group, at least one hydrogen atom in B1 and B2 may be substituted with an -Sp1-P3 group, a halogen atom, a —CN, —NO₂, —NCO, —NCS, —OCN, —SCN, or —SF₅ group, or a linear or branched alkyl, alkenyl, or aralkyl group of 1 to 12 carbon atoms, two adjacent hydrogen atoms in B1 and B2 may be substituted with a linear or branched alkylene or alkenylene group of 1 to 12 carbon atoms so that a ring structure can be formed, at least one hydrogen atom of an alkyl, alkenyl, alkylene, alkenylene, or aralkyl group in B1 and B2 may be substituted with an -Sp1-P3 group, each —CH₂— group in an alkyl, alkenyl, alkylene, alkenylene, or aralkyl group in B1 and B2 may be substituted with an —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that there are no adjacent oxygen, sulfur, and nitrogen atoms,
P3 represents a radically-polymerizable group,
Sp1 represents a linear, branched, or cyclic alkylene or alkyleneoxy group of 1 to 6 carbon atoms, or a direct bond,
m is 1 or 2,
a dotted line linking B1 and Y and a dotted line linking B2 and Y indicate that a linkage may exist between B1 and B2 with Y interposed therebetween, and
Y represents a —CH₂—, —CH₂CH₂—, —CH═CH—, —O—, —S—, —NH—, —N(CH₃)—, —N(C₂H₅)—, —N(C₃H₇)—, —N(C₄H₉)—, —OCH₂—, —CH₂O—, —SCH₂—, or —CH₂S— group, or a direct bond.

36. The liquid crystal display device according to claim 35, wherein said compound represented by formula (2) is at least one of compounds represented by formulae (2-1) to (2-8): 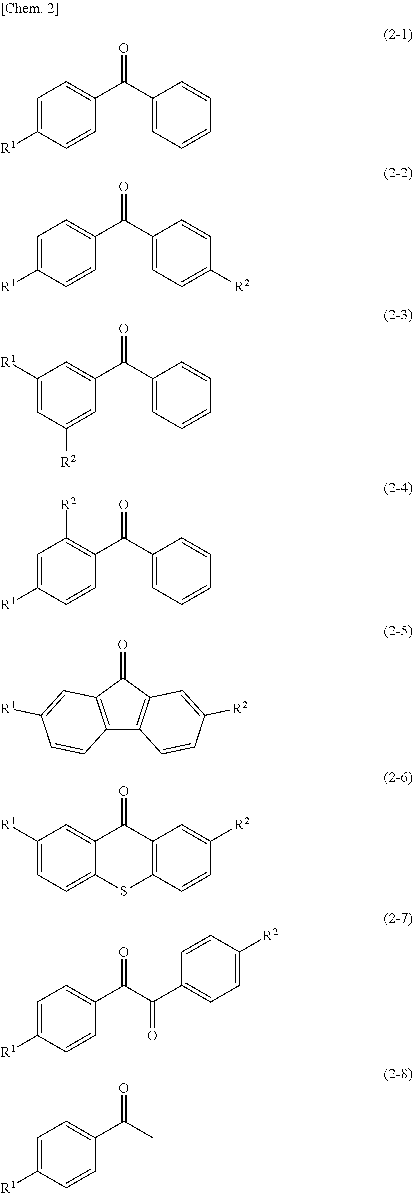
wherein
R1 and R2 are the same or different and each represent an -Sp1-P3 group, a hydrogen atom, a halogen atom, a —CN, —NO₂, —NCO, —NCS, —OCN, —SCN, or —SF₅ group, or a linear or branched alkyl, aralkyl, or phenyl group of 1 to 12 carbon atoms, at least one of R1 and R2 includes an -Sp1-P3 group,
P3 represents a radically-polymerizable group,
Sp1 represents a linear, branched, or cyclic alkylene or alkyleneoxy group of 1 to 6 carbon atoms, or a direct bond,
when R1 and R2 are linear or branched alkyl, aralkyl, or phenyl groups of 1 to 12 carbon atoms, at least one hydrogen atom in R1 and R2 may be substituted with a fluorine atom, a chlorine atom, or an -Sp1-P3 group, and
a —CH₂— group in R1 and R2 may be substituted with an —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CF₂CH₂—, —CH₂CF₂—, —CF₂CF₂—, —CH═CH—, —CF═CF—, —C≡C—, —CH═CH—COO—, or —OCO—CH═CH— group, provided that there are no adjacent oxygen, sulfur, and nitrogen atoms.

37. The liquid crystal display device according to claim 35, wherein P3 represents an acryloyloxy, methacryloyloxy, acryloylamino, methacryloylamino, vinyl, or vinyloxy group.

38. The liquid crystal display device according to claim 30, wherein said polymerizable monomer includes a compound having at least two radically-polymerizable groups and a structure capable of undergoing a photoirradiation-induced self-cleavage reaction to produce a radical.

39. The liquid crystal display device according to claim 38, wherein said compound having at least two radically-polymerizable groups and a structure capable of undergoing a photoirradiation-induced self-cleavage reaction to produce a radical includes at least one polymerizable monomer represented by formula (3): 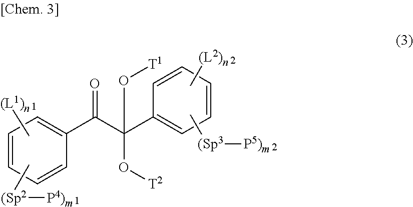
wherein
T1 represents a linear or branched alkyl or alkenyl group of 1 to 4 carbon atoms or Sp4-P6,
T2 represents a linear or branched alkyl or alkenyl group of 1 to 4 carbon atoms or Sp5-P7,
P4, P5, P6, and P7 are the same or different and each represent a radically-polymerizable group, wherein the total number of radically-polymerizable groups is equal to or greater than 2,
Sp2 represents a linear, branched, or cyclic alkylene, alkyleneoxy, or alkylenecarbonyloxy group of 1 to 6 carbon atoms, or a direct bond, when m1 is equal to or greater than 2, at least two occurrences of Sp2 may be the same or different,
Sp3 represents a linear, branched, or cyclic alkylene, alkyleneoxy, or alkylenecarbonyloxy group of 1 to 6 carbon atoms, or a direct bond, when m2 is equal to or greater than 2, at least two occurrences of Sp3 may be the same or different,
Sp4 represents a linear, branched, or cyclic alkylene, alkyleneoxy, or alkylenecarbonyloxy group of 1 to 6 carbon atoms,
Sp5 represents a linear, branched, or cyclic alkylene, alkyleneoxy, or alkylenecarbonyloxy group of 1 to 6 carbon atoms,
L1 represents a fluorine atom, an —OH group, or a linear or branched alkyl, alkenyl, or aralkyl group of 1 to 12 carbon atoms, when n1 is equal to or greater than 2, at least two occurrences of L1 may be the same or different,
when two L1 moieties are bonded to two adjacent carbon atoms, respectively, on an aromatic ring, the two L1 moieties may be linked together to form a ring structure, and the two L1 moieties are the same or different and each a linear or branched alkylene or alkenylene group of 1 to 12 carbon atoms,
L2 represents a fluorine atom, an —OH group, or a linear or branched alkyl, alkenyl, or aralkyl group of 1 to 12 carbon atoms, when n2 is equal to or greater than 2, at least two occurrences of L2 may be the same or different,
when two L2 moieties are bonded to two adjacent carbon atoms, respectively, on an aromatic ring, the two L2 moieties may be linked together to form a ring structure, and the two L2 moieties are the same or different and each a linear or branched alkylene or alkenylene group of 1 to 12 carbon atoms,
at least one hydrogen atom of an alkyl, alkenyl, alkylene, alkenylene, or aralkyl group in L1 and L2 may be substituted with a fluorine atom or an —OH group,
each —CH₂— group in an alkyl, alkenyl, alkylene, alkenylene, or aralkyl group in L1 and L2 may be substituted with an —O—, —S—, —NH—, —CO—, —COO—, —OCO—, —O—COO—, —OCH₂—, —CH₂O—, —SCH₂—, —CH₂S—, —N(CH₃)—, —N(C₂H₅)—, —N(C₃H₇)—, —N(C₄H₉)—, —CF₂O—, —OCF₂—, —CF₂S—, —SCF₂—, —N(CF₃)—, —CH₂CH₂—, —CH₂CF₂—, —CF₂CH₂—, —CF₂CF₂—, —CH═CH—, —CF═CF—, —C≡C—, —CH═CH—COO—, or —OCO—CH═CH— group, provided that there are no adjacent oxygen, sulfur, and nitrogen atoms,
m1 is an integer of 1 to 3,
m2 is an integer of 0 to 3,
n1 is an integer of 0 to 4,
n2 is an integer of 0 to 4,
the sum of m1 and n1 is an integer of 1 to 5,
the sum of m2 and n2 is an integer of 0 to 5, and
the sum of m1 and m2 is an integer of 1 to 6.

40. The liquid crystal display device according to claim 38, wherein said radically-polymerizable group is an acryloyloxy, methacryloyloxy, acryloylamino, methacryloylamino, vinyl, or vinyloxy group.

41. The liquid crystal display device according to claim 38, wherein said compound having at least two radically-polymerizable groups and a structure capable of undergoing a photoirradiation-induced self-cleavage reaction to produce a radical includes at least one polymerizable monomer represented by formula (4): 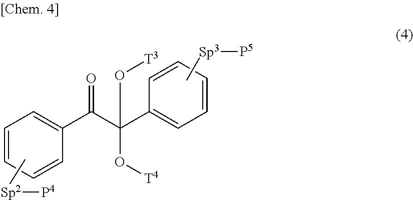
wherein
T3 represents a linear or branched alkyl or alkenyl group of 1 to 4 carbon atoms,
T4 represents a linear or branched alkyl or alkenyl group of 1 to 4 carbon atoms,
P4 and P5 are the same or different and each represent a radically-polymerizable group,
Sp2 represents a linear, branched, or cyclic alkylene, alkyleneoxy, or alkylenecarbonyloxy group of 1 to 6 carbon atoms, or a direct bond, and
Sp3 represents a linear, branched, or cyclic alkylene, alkyleneoxy, or alkylenecarbonyloxy group of 1 to 6 carbon atoms, or a direct bond.

42. The liquid crystal display device according to 34, wherein said polymerizable monomer further includes a polymerizable monomer having at least one ring structure and a polyfunctional polymerizable group.

43. The liquid crystal display device according to claim 42, wherein said polymerizable monomer having at least one ring structure and a polyfunctional polymerizable group includes at least one polymerizable monomer represented by formula (5):
P8-S1-B3-(Z2-B4)k-S2-P9 (5)
wherein
P8 and P9 are the same or different and each represent an acryloyloxy, methacryloyloxy, acryloylamino, methacryloylamino, vinyl, or vinyloxy group,
B3 and B4 are the same or different and each represent a 1,4-phenylene, 4,4′-biphenylene, naphthalene-2,6-diyl, anthracene-2,6-diyl, phenanthrene-2,7-diyl, phenanthrene-3,6-diyl, phenanthrene-1,6-diyl, or phenanthrene-1,8-diylgroup,
at least one hydrogen atom in B3 and B4 may be substituted with a halogen atom or a methyl group,
Z2 represents COO, OCO, O, CO, NHCO, CONH, or S, or represents a direct bond between B3 and B4 or between B4 and B4,
k is 0, 1, or 2, and
S1 and S2 are the same or different and each represent (CH₂)ᵢ, wherein i is an integer of 1 to 18, (CH₂—CH₂—O)ⱼ, wherein j is an integer of 1 to 6, or a direct bond between P8 and B3, between B3 and P9, or between B4 and P9.

44. The liquid crystal display device according to claim 43, wherein said compound represented by formula (5) is at least one of compounds represented by formulae (5-1) to (5-4): 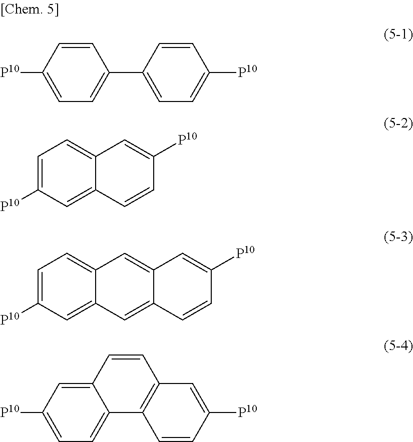
wherein at least two occurrences of P10 are the same or different and each represent an acryloyloxy, methacryloyloxy, acryloylamino, methacryloylamino, vinyl, or vinyloxy group.

45. The liquid crystal display device according to claim 30, wherein said alignment film is a polyimide, polyamide, polyvinyl alcohol, polyvinyl acetal, polysiloxane, polyorganosiloxane, polymaleimide, or derivative of any of the foregoing containing, in a side chain, a functional group having dielectric anisotropy.

46. A method for manufacturing the liquid crystal display device according to claim 30, the method comprising the steps of:
forming said alignment film on at least one surface of each of said pair of substrates;
arranging said pair of substrates opposite to each other with said alignment film placed inside;
introducing a liquid crystal composition between said pair of substrates, wherein said liquid crystal composition contains said liquid crystal molecule and said polymerizable monomer; and
polymerizing said polymerizable monomer to form said polymer layer.

47. The method according to claim 46, wherein said polymer layer-forming step includes the step of polymerizing said polymerizable monomer while a voltage equal to or greater than a threshold for liquid crystal response is applied to said liquid crystal composition.

48. The method according to claim 46, wherein said polymer layer-forming step includes the step of polymerizing said polymerizable monomer with no voltage applied to said liquid crystal composition.

49. The method according to claim 46, wherein said polymer layer-forming step includes the step of polymerizing said polymerizable monomer by photoirradiation of said liquid crystal composition.
